(19) United States
(12) Patent Application Publication
(10) Pub. No.: US 2008/0123072 A1
(43) Pub. Date: May 29, 2008

(54) Projection Head Focus Position Measurement Method And Exposure Method

(75) Inventor: Kazuteru Kowada, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/910,226

(22) PCT Filed: Mar. 30, 2006
(86) PCT No.: PCT/JP2006/307286

§ 371 Date: Nov. 14, 2007

(30) Foreign Application Priority Data
Mar. 30, 2005 (JP) 2005-098506
May 30, 2005 (JP) 2005-157239
Jun. 1, 2005 (JP) 2005-160894

(51) Int. Cl. G03B 27/52

(52) U.S. Cl. 355/55

(57) ABSTRACT

The same test image pattern is projected onto different regions of a photosensitive material on a substrate by a projection head while one of a projection distance from the projection head to the photosensitive material and a focus position is changed. Accordingly, each of the regions of the photosensitive material is exposed to light. The photosensitive material which has been exposed to light is developed. Then, the focus position of the projection head is obtained based on a relationship between a projection distance or focus position corresponding to a region in which the photosensitive material has been removed from the substrate by development and a projection distance or focus position corresponding to a region in which the photosensitive material has not been removed from the substrate by development among the regions of the photosensitive material.

### TECHNICAL FIELD

The present invention relates to a projection head focus position measurement method and an exposure method. Particularly, the present invention relates to a projection head focus position measurement method for measuring the focus position of an image pattern projected by a projection head. The present invention also relates to an exposure method for performing exposure by applying the projection head focus position measurement method.

### BACKGROUND ART

Conventionally, an exposure apparatus is well known as an example of a projection apparatus in which a projection head for projecting an image is provided (please refer to Japanese Unexamined Patent Publication No. 2004-001244). The exposure apparatus includes a plurality of exposure heads, each mounted with a DMD (digital micromirror device). In the exposure apparatus, an image pattern is projected onto a photosensitive material to expose the photosensitive material to light. Further, it is well known that in the exposure apparatus, a stage for exposure, on which the photosensitive materials is placed, is conveyed in one direction to a position below an exposure head to expose the photosensitive material to light by projecting an image onto the photosensitive material.

In the exposure apparatus, adjustment of the focus position of an exposure head is required to accurately project an image onto the photosensitive material. When adjustment of the focus position is required, an image pattern for checking the focus position is projected from the exposure head onto regions of the photosensitive material, which are different from each other. The position of the photosensitive material with respect to the exposure head is changed stepwise and the image pattern is projected onto the photosensitive material each time the position of the photosensitive material is changed. Accordingly, each of the regions of the photosensitive material is exposed to light. Then, the photosensitive material which has been exposed to light by projection of the image pattern for checking the focus position is developed. An image pattern formed in each of the regions is observed with a microscope and a region in which the image pattern is most sharply formed is selected from the regions. Then, the position of the photosensitive material when the region which has been selected as the most sharply formed region was exposed to light is obtained as the focus position of the exposure head.

However, since the test for determining the region in which the image pattern is most sharply formed is a sensory test, it is necessary that the test is performed by a skilled operator. Further, there is a problem that the reliability of the test result differs according to the level of the skill of the operator.

### DISCLOSURE OF INVENTION

In view of the foregoing circumstances, it is an object of the present invention to provide a projection head focus position measurement method for more accurately determining the focus position of a projection head. It is another object of the present invention to provide an exposure method for performing exposure by applying the projection head focus position measurement method.

A projection head focus position measurement method according to the present invention is a method for measuring the focus position of a projection head, comprising the steps of:

preparing a photosensitive material which is superposed on a substrate;

projecting a test image pattern onto each of regions of the photosensitive material, which are different from each other, by a projection head while changing one of a projection distance from the projection head to the photosensitive material, onto which the image pattern is projected by the projection head, and the focus position of the projection head;

developing the photosensitive material onto which the test image pattern has been projected; and

obtaining a focus position, wherein the photosensitive material is a photosensitive material in which a region of the photosensitive material which is removed from the substrate when the photosensitive material is developed after exposure to light and a region of the photosensitive material which is not removed from the substrate when the photosensitive material is developed after exposure to light are determined based on exposure condition during exposure, namely based on the amount of exposure light and the size of an exposed area, and wherein the focus position is obtained based on one of a projection distance and the focus position of the projection head which correspond to a boundary region between a region in which the photosensitive material has been removed from the substrate by development and a region in which the photosensitive material has not been removed from the substrate by development.

The test image pattern may include line portions which are projected so that the photosensitive material is not removed from the substrate and a space portion which is projected between the line portions so that the photosensitive material is removed from the substrate.

It is preferable that the width of the line portion projected on the focus position by the projection head is less than the adhesion limit size of the photosensitive material with respect to the substrate. Further, it is more preferable that the width of the line portion is in the range of 50% to 90% of the adhesion limit size.

It is preferable that the width of the space portion projected on the focus position by the projection head is greater than the resolution limit size of the projection head. Further, it is more preferable that the width of the space portion is in the range of 120% to 150% of the resolution limit size.

The size of a region of the photosensitive material, onto which the test image pattern is projected, may be a visible size.

The boundary region may be a region in which the photosensitive material has not been removed from the substrate by development, and which is adjacent to a region in which the photosensitive material has been removed from the substrate by development.

In the projection head focus position measurement method, the focus position to be selected may be determined by further performing etching processing on the substrate and photosensitive material after the photosensitive material is developed. Further, a plurality of projection heads may be provided and a focus position to be selected may be determined for each of the plurality of projection heads.

The focus position to be selected may be the middle position of projection distances, each corresponding to one of two boundary regions which are present among the regions of the photosensitive material after development. Alternatively, the focus position to be selected may be the middle position of the focus positions of the projection head, each corresponding to one of the two boundary regions which are present among the regions of the photosensitive material after development. Specifically, when the focus position of the projection head is obtained by changing the projection distances, the middle position of the projection distances, each corresponding to one of two boundary regions, may be obtained as the focus position of the projection head. The two boundary regions are regions which are present among the regions of the photosensitive material after development. Alternatively, when the focus position of the projection head is obtained by changing the focus positions, the middle position of the focus positions of the projection head, each corresponding to one of the two boundary regions which are present among the regions of the photosensitive material after development, may be obtained as the focus position of the projection head.

The regions of the photosensitive material which are different from each other, and onto each of which the test image pattern is projected, may be arranged in a row.

The focus position to be selected may be determined based on one of a projection distance and the focus position of the projection head, each corresponding to a boundary region obtained for each of two or more kinds of test image pattern. Each of the two or more kinds of test image pattern is an image pattern including a line portion and a space portion. Further, the width of the line portion and/or the width of the space portion in each of the two or more kinds of test image pattern is different from the width of the line portion and/or the width of the space portion in the other image pattern or image patterns.

The focus position to be selected may be determined based on one of a projection distance and the focus position of the projection head, each corresponding to a boundary region obtained for each of two or more kinds of test image pattern. The two or more kinds of test image pattern are image patterns, each including a line portion, and the direction of the line portion in each of the image patterns is different from that of the line portion in the other image pattern or image patterns.

When the photosensitive material is distorted, the test image pattern may be projected by compensating the distortion so that the test image pattern is projected onto the photosensitive material in a condition similar to that of an image pattern projected when the photosensitive material is not distorted.

An exposure method according to the present invention is an exposure method comprising the steps of:

obtaining an image pattern by performing spatial light modulation on light emitted from a light source; and

exposing the photosensitive material to light by forming the image pattern on the same photosensitive material by each of a plurality of exposure heads, each including a spatial light modulator, wherein the spatial light modulator includes a multiplicity of two-dimensionally arranged modulation elements which modulate incident light, and wherein the focus position of each of the exposure heads is measured by applying the projection head focus position measurement method to measurement of the focus position when the photosensitive material is exposed to light by the plurality of exposure heads, and wherein the photosensitive material is exposed to light by each of the exposure heads by correcting, based on the focus position of each of the exposure heads, a shift in the focus position of the image pattern projected onto the photosensitive material by each of the exposure heads.

The projection head focus position measurement method includes a first case and a second case. In the first case, the focus position of the projection head is fixed and a projection distance from the photosensitive material to the projection head is changed. While the projection distance is changed, image patterns are projected onto the photosensitive material by the projection head. Then, the focus position of the projection head is obtained based on the result of development of each of the image patterns which have been projected onto the regions of the photosensitive material to expose the photosensitive material to light. Specifically, in the first case, a projection distance when the focus position of the projection head is positioned on the photosensitive material is obtained. In the second case, the projection distance from the projection head to the photosensitive material is fixed and the focus position of the projection head is changed. While the focus position is changed, image patterns are projected onto the photosensitive material by the projection head. Then, the focus position of the projection head is obtained based on the result of development of each of the image patterns which have been projected onto regions of the photosensitive material to expose the photosensitive material to light. Specifically, in the second case, a focus adjustment condition of the projection head when the focus position of the projection head is positioned on the photosensitive material is obtained.

The “photosensitive material in which a region of the photosensitive material which is removed from the substrate when the photosensitive material is developed after exposure to light and a region of the photosensitive material which is not removed from the substrate when the photosensitive material is developed after exposure to light are determined based on the amount of exposure light” may be a photosensitive material in which a region of the photosensitive material which has been exposed to a predetermined amount of light or more light remains on the substrate and a region of the photosensitive material which has not been exposed to the predetermined amount of light or more light is removed from the substrate when the photosensitive material is developed after exposure to light. Alternatively, the photosensitive material may have an opposite characteristic from that of the photosensitive material in the above example. Specifically, the photosensitive material may be a photosensitive material in which a region of the photosensitive material which has been exposed to a predetermined amount of light or more light is removed from the substrate and a region of the photosensitive material which has not been exposed to the predetermined amount of light or more light remains on the substrate when the photosensitive material is developed after exposure to light.

If the photosensitive material is a photosensitive material in which a region of the photosensitive material which has been exposed to a predetermined amount of light or more light remains on the substrate and a region of the photosensitive material which has not been exposed to the predetermined amount of light or more light is removed from the substrate, the “photosensitive material in which a region of the photosensitive material which is removed from the substrate when the photosensitive material is developed after exposure to light and a region of the photosensitive material which is not removed from the substrate when the photosensitive material is developed after exposure to light are determined based on the size of an exposed area” may be a photosensitive material in which an exposed portion of the photosensitive material, of which the size is more than or equal to a predetermined exposure size, remains on the substrate and an exposed portion of the photosensitive material, of which the size is less than the predetermined exposure size, is removed from the substrate when the photosensitive material is developed after exposure to light. Alternatively, the photosensitive material may have an opposite characteristic from that of the photosensitive material in the above example. Specifically, if the photosensitive material is a photosensitive material in which a region of the photosensitive material which has been exposed to a predetermined amount of light or more light is removed from the substrate and a region of the photosensitive material which has not been exposed to the predetermined amount of light or more light remains on the substrate, the photosensitive material may be a photosensitive material in which an unexposed portion of the photosensitive material, of which the size is more than or equal to a predetermined exposure size, remains on the substrate and an unexposed portion of the photosensitive material, of which the size is less than the predetermined exposure size, is removed from the substrate when the photosensitive material is developed after exposure to light. Here, the predetermined exposure size refers to an adhesion limit size, which will be described later.

The focus position refers to a position at which an image pattern is accurately formed.

The phrase “projection distance corresponding to a region” refers to a projection distance when the region is exposed to light.

It is preferable that the test image pattern projected onto each of regions of the photosensitive material, which are different from each other, is a test image pattern which forms the same image when the test image pattern is accurately formed in each of the regions of the photosensitive material.

The expression “to perform exposure while changing a projection distance” refers to a case in which exposure is performed each time the projection distance is changed stepwise. The expression also refers to a case in which exposure is performed while the projection distance is continuously changed.

The “regions of the photosensitive material, which are different from each other” may be different regions of the same photosensitive material. Alternatively, the regions may be regions of different photosensitive materials.

The adhesion limit size refers to the minimum size of a region made of the photosensitive material, which can be held on the substrate when the photosensitive material superposed on the substrate is developed after exposure to light. Therefore, after the photosensitive material is developed, no region which has a size smaller than the adhesion limit size remains on the substrate.

The resolution limit size refers to the minimum size of the width of a space portion which can be accurately formed by a projection head.

In a method for determining the focus position of an image pattern projected by a projection head based on a projection distance, the focus position may be determined, for example, by obtaining the middle position of two kinds of projection distance. Each of the two kinds of projection distance is a projection distance corresponding to one of two kinds of region, in each of which the photosensitive material has not been removed from the substrate by development, and each of which is adjacent to a region in which the photosensitive material has been removed from the substrate by development. Specifically, if the two kinds of projection distance are a first projection distance T1 and a second projection distance T2, a projection distance Tp can be obtained by the following equation:

Tp=(T1+T2)/2.

The projection distance Tp is a projection distance corresponding to the middle position, which is the focus position when the projection head is focused on the photosensitive material. Accordingly, the position represented by the projection distance Tp can be obtained as the focus position of the projection head.

The focus position of the projection head refers to a position on which an image pattern is accurately projected (formed) by the projection head.

The test image pattern may be an image pattern including both a region which illuminates the photosensitive material and a region which does not illuminate the photosensitive material.

The projection head focus position measurement method may be, for example, a projection head focus position measurement method for measuring the focus position of an image pattern projected by a projection head. The projection head focus position measurement method may be a method comprising the steps of:

preparing a photosensitive material which is superposed on a substrate;

projecting a test image pattern onto each of regions of the photosensitive material, which are different from each other, by a projection head while changing one of a projection distance from the projection head to the photosensitive material, onto which the image pattern is projected by the projection head, and the focus position of the projection head;

developing the photosensitive material onto which the test image pattern has been projected; and

obtaining the focus position of an image pattern projected onto the photosensitive material by the projection head, wherein the photosensitive material is a photosensitive material in which a region of the photosensitive material which is removed from the substrate when the photosensitive material is developed after exposure to light and a region of the photosensitive material which is not removed from the substrate when the photosensitive material is developed after exposure to light are determined based on the amount of exposure light and the size of an exposed area in exposure, and wherein the focus position of the image pattern is obtained based on one of a projection distance and the focus position of the projection head which correspond to each of regions in which the photosensitive material has not been removed from the substrate by development, and each of which is adjacent to a region in which the photosensitive material has been removed from the substrate by development.

Further, the projection head focus position measurement method may be, for example, a projection head focus position measurement method for measuring the focus position of a projection head, comprising the steps of:

preparing a photosensitive material which is superposed on a substrate;

projecting the same test image pattern onto each of regions of the photosensitive material, which are different from each other, by a projection head while changing one of a projection distance from the projection head to the photosensitive material, onto which the image pattern is projected by the projection head, and the focus position of the projection head;

developing the photosensitive material onto which the test image pattern has been projected; and

obtaining the focus position of an image pattern projected onto the photosensitive material by the projection head, wherein the photosensitive material is a photosensitive material in which an exposed region of the photosensitive material remains and an unexposed region is removed from the substrate when the photosensitive material is developed after exposure to light, and wherein an exposed portion of the photosensitive material which is larger than a predetermined exposure size remains on the substrate and an exposed area which is smaller than the predetermined exposure size is removed from the substrate, and wherein the focus position of the image pattern is obtained based on one of a projection distance and the focus position of the projection head which correspond to each region in which an exposed region of the photosensitive material has not been removed from the substrate by development, and which is adjacent to the region in which an exposed region of the photosensitive material has been removed from the substrate by development.

Further, the projection head focus position measurement method may be, for example, a projection head focus position measurement method for measuring the focus position of a projection head, comprising the steps of:

preparing a photosensitive material which is superposed on a substrate;

projecting the same test image pattern onto each of regions of the photosensitive material, which are different from each other, by a projection head while changing one of a projection distance from the projection head to the photosensitive material, onto which the image pattern is projected by the projection head, and the focus position of the projection head;

developing the photosensitive material onto which the test image pattern has been projected; and

obtaining the focus position of an image pattern projected onto the photosensitive material by the projection head, wherein the photosensitive material is a photosensitive material in which an unexposed region of the photosensitive material remains and an exposed region is removed from the substrate when the photosensitive material is developed after exposure to light, and wherein an unexposed portion of the photosensitive material which is larger than a predetermined exposure size remains on the substrate and an unexposed portion which is smaller than the predetermined exposure size is removed from the substrate, and wherein the focus position of the image pattern is obtained based on one of a projection distance and the focus position of the projection head which correspond to each region in which an unexposed region of the photosensitive material has not been removed from the substrate by development, and which is adjacent to the region in which an unexposed region of the photosensitive material has been removed from the substrate by development.

The inventor of the present invention has found that when various kinds of test image pattern are projected onto a photosensitive material on a substrate to expose the photosensitive material to light and the photosensitive material is developed, only two states occur and no intermediate state between the two states occurs. The two states are a state in which the photosensitive material in a region, onto which a test image pattern has been projected to expose the photosensitive material to light, is removed from the substrate when the photosensitive material is developed and a state in which the photosensitive material in a region, onto which a test image pattern has been projected to expose the photosensitive material to light, is not removed from the substrate when the photosensitive material is developed. Further, the inventor has conceived of the idea that it is possible to set a condition so that when the photosensitive material is placed in the vicinity of the focus position of the test image pattern which is projected by the projection head, the photosensitive material in the region, onto which the test image pattern is projected to expose the photosensitive material to light, is removed and that when the photosensitive material is not placed in the vicinity of the focus position, the photosensitive material in the region, onto which the test image pattern is projected to expose the photosensitive material to light, is not removed. Further, the inventor has conceived of the idea that generally, it is possible to set a condition so that the state of the photosensitive material changes between the two states based on the shift amount of the photosensitive material from the focus position. Accordingly, the inventor has reached the present invention.

In the projection head focus position measurement method according to the present invention, a photosensitive material which is superposed on a substrate is prepared. The photosensitive material is a photosensitive material in which a region of the photosensitive material which is removed from the substrate when the photosensitive material is developed after exposure to light and a region of the photosensitive material which is not removed from the substrate when the photosensitive material is developed after exposure to light are determined based on the amount of exposure light and the size of an exposed area. Further, a test image pattern is projected onto each of regions of the photosensitive material, which are different from each other, by a projection head to expose the regions of the photosensitive material to light while changing one of a projection distance from the projection head to the photosensitive material, onto which the image pattern is projected by the projection head, and the focus position of the projection head. Then, the photosensitive material onto which the test image pattern has been projected is developed. Then, a focus position is obtained based on one of a projection distance and the focus position of the projection head which correspond to a boundary region between the region in which the photosensitive material has been removed from the substrate by development and the region in which the photosensitive material has not been removed from the substrate by development. Therefore, unlike the methods according to the conventional technique, a region in which the photosensitive material is removed by development and a region in which the photosensitive material is not removed by development can be determined without relying on a sensory test. Therefore, it is possible to more accurately determine the focus position of the projection head.

Specifically, when a photosensitive material is placed at an equal distance from the focus position of an image pattern on either the front side (also referred to as a front focus side) or the back side (also referred to as a back focus side) of the focus position of the image pattern projected by the projection head, an image pattern projected onto each of the photosensitive materials is blurred. Further, the degree of blur is substantially the same in both of the image patterns, each projected onto the photosensitive material placed on the front side or back side of the focus position. Further, it is possible to set a condition so that the state of the photosensitive material changes between two states based on whether the photosensitive material is placed in the vicinity of the focus position or not. The two states are a case in which the photosensitive material is removed from a region of the photosensitive material, onto which the image pattern has been projected, and a case in which the photosensitive material is not removed from the region of the photosensitive material, onto which image pattern has been projected. Specifically, it is possible to set a condition so that the state of the photosensitive material changes between the two cases (hereinafter, referred to as two states) on each of the front side and the back side of the focus position. The condition is set, for example, by projecting a test image pattern onto each of regions of the photosensitive material, which are different from each other, while the photosensitive material is moved from the front side of the focus position to the back side of the focus position of the projection head and by developing the photosensitive material. Further, a position of the photosensitive material on the front side at which the state changes between the two states and a position of the photosensitive material on the back side at which the state changes between the two states are determined. Then, the middle position of the two positions can be determined as the focus position at which an image pattern is accurately formed on the photosensitive material. Accordingly, unlike the methods according to the conventional technique, it is possible to more accurately determine the focus position of the projection head without relying on a sensory test.

Further, if the test image pattern includes a line portion which is projected so that the photosensitive material is not removed from the substrate and a space portion which is projected so that the photosensitive material is removed from the substrate, it is possible to more accurately set a condition so that the state of the photosensitive material changes between two states. The two states are a state in which the photosensitive material is removed from the substrate and a state in which the photosensitive material is not removed from the substrate. Therefore, it is possible to more accurately determine the focus position of the projection head.

Further, if the width of the line portion projected on the focus position by the projection head is less than the adhesion limit size of the photosensitive material with respect to the substrate, it is possible to more accurately set a condition so that the state of the photosensitive material changes between the two states. Further, if the width of the line portion is in the range of 50% to 90% of the adhesion limit size, it is possible to even more accurately set a condition so that the state of the photosensitive material changes between the two states. Accordingly, it is possible to more accurately determine the focus position of the projection head.

Further, if the width of the space portion projected on the focus position by the projection head is greater than the resolution limit size of the projection head, it is possible to more accurately set a condition so that the state of the photosensitive material changes between the two states. Further, if the width of the space portion is in the range of 120% to 150% of the resolution limit size, it is possible to even more accurately set a condition so that the state of the photosensitive material changes between the two states. Accordingly, it is possible to more accurately determine the focus position of the projection head.

Further, if the size of a region of the photosensitive material, onto which the test image pattern is projected, is a visible size, it is possible to more easily determine the focus position of the projection head.

Further, if the focus position to be selected is one of the middle position of projection distances, each corresponding to one of two boundary regions which are present among the regions of the photosensitive material, and the middle position of the focus positions of the projection heads, each corresponding to one of the two boundary regions which are present among the regions of the photosensitive material, it is possible to more accurately determine the focus position of the projection head. Further, if the regions of the photosensitive material which are different from each other, and onto each of which the test image pattern is projected, are arranged in a row, and if each of the regions on the photosensitive material is formed by sequentially projecting an image pattern on the photosensitive material while the projection distance or the focus position of the projection head is changed stepwise by an equal distance, the focus position to be selected can be determined so that the focus position corresponds to a region at the middle between the two boundary regions among the regions arranged in a row.

### BRIEF DESCRIPTION OF DRAWINGS

FIG. 1A is a conceptual diagram illustrating a projection head focus position measurement method according to an embodiment of the present invention;

FIG. 1B is a conceptual diagram illustrating a projection head focus position measurement method according to an embodiment of the present invention;

FIG. 2 is a diagram illustrating line portions and space portions in a test image pattern;

FIG. 3A is a diagram illustrating a process of projecting a test image pattern onto a photosensitive material to expose the photosensitive material to light while a projection distance is changed;

FIG. 3B is a diagram illustrating a process of projecting a test image pattern onto a photosensitive material to expose the photosensitive material to light while a projection distance is changed;

FIG. 3C is a diagram illustrating a process of projecting a test image pattern onto a photosensitive material to expose the photosensitive material to light while a projection distance is changed;

FIG. 3D is a diagram illustrating a process of projecting a test image pattern onto a photosensitive material to expose the photosensitive material to light while a projection distance is changed;

FIG. 4 is a diagram illustrating a region of a photosensitive material, onto which a test image pattern has been projected to expose the photosensitive material to light;

FIG. 5 is a diagram illustrating a photosensitive material which has been exposed to light;

FIG. 6 is a diagram illustrating a photosensitive material which has been developed after three kinds of test image pattern have been projected onto the photosensitive material to expose the photosensitive material to light;

FIG. 7A1 is a diagram illustrating a process of exposing and developing the photosensitive material;

FIG. 7A2 is a diagram illustrating a process of exposing and developing the photosensitive material;

FIG. 7B1 is a diagram illustrating a process of exposing and developing the photosensitive material;

FIG. 7B2 is a diagram illustrating a process of exposing and developing the photosensitive material;

FIG. 7C1 is a diagram illustrating a process of exposing and developing the photosensitive material;

FIG. 7C2 is a diagram illustrating a process of exposing and developing the photosensitive;

FIG. 7D1 is a diagram illustrating a process of exposing and developing the photosensitive material;

FIG. 7D2 is a diagram illustrating a process of exposing and developing the photosensitive material;

FIG. 8A is a diagram illustrating a test image pattern including lines which are orthogonal to each other;

FIG. 8B is a diagram illustrating a test image pattern including lines which are orthogonal to each other;

FIG. 8C is a diagram illustrating a test image pattern including lines which are orthogonal to each other;

FIG. 9 is a diagram illustrating each region of a photosensitive material which has been exposed and developed to check the fluctuation in the focus position;

FIG. 10 is a schematic diagram illustrating the structure of an optical system of an exposure apparatus;

FIG. 11 is a schematic perspective view of the whole exposure apparatus;

FIG. 12 is a perspective view illustrating a process of exposing a photosensitive material to light by a projection head which is housed in an exposure unit;

FIG. 13 is an enlarged perspective view illustrating the structure of a DMD;

FIG. 14A is a perspective view illustrating the operation of a micromirror;

FIG. 14B is a perspective view illustrating the operation of a micromirror;

FIG. 15A is a plan view illustrating the conveyance path of a pixel light beam when the DMD is not inclined;

FIG. 15B is a plan view illustrating the conveyance path of a pixel light beam when the DMD is inclined;

FIG. 16 is a schematic diagram illustrating the structure of a focus position automatic adjustment unit;

FIG. 17 is a perspective view illustrating a position in an exposure apparatus, to which a focus position automatic adjustment unit is attached; and

FIG. 18 is an enlarged perspective view illustrating a pair of wedge prisms, which forms the focus position automatic adjustment unit.

### BEST MODE FOR CARRYING OUT THE INVENTION

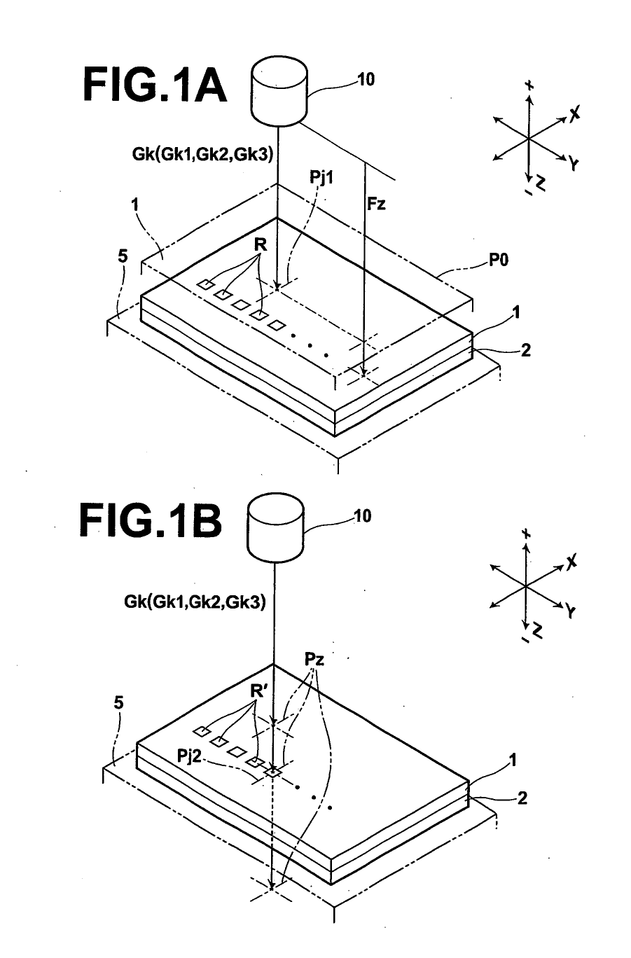

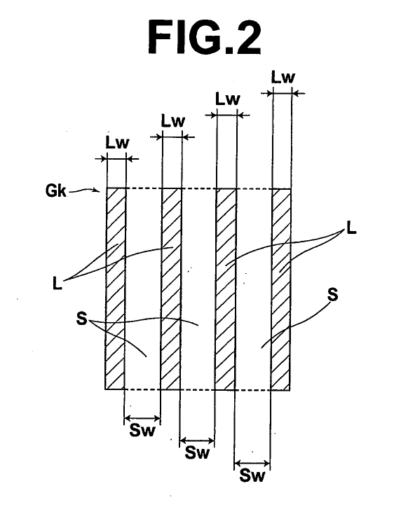

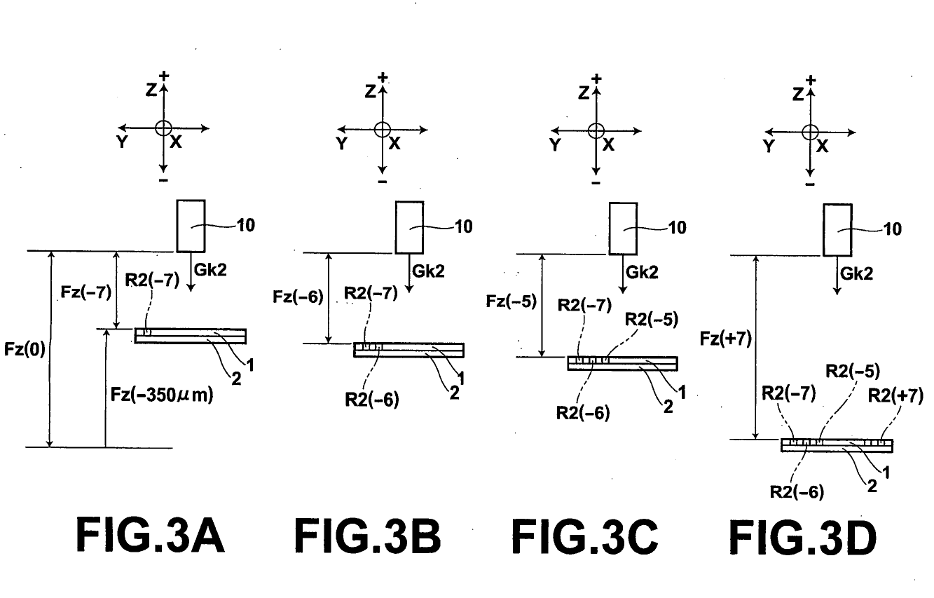

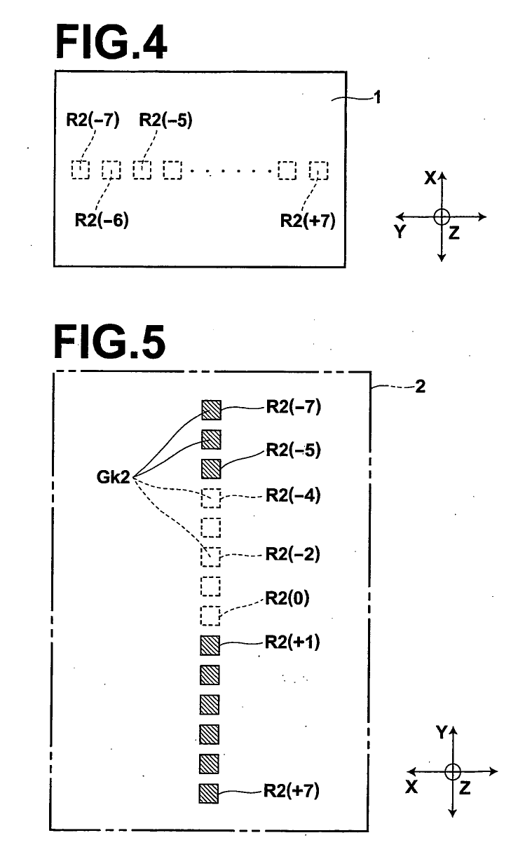

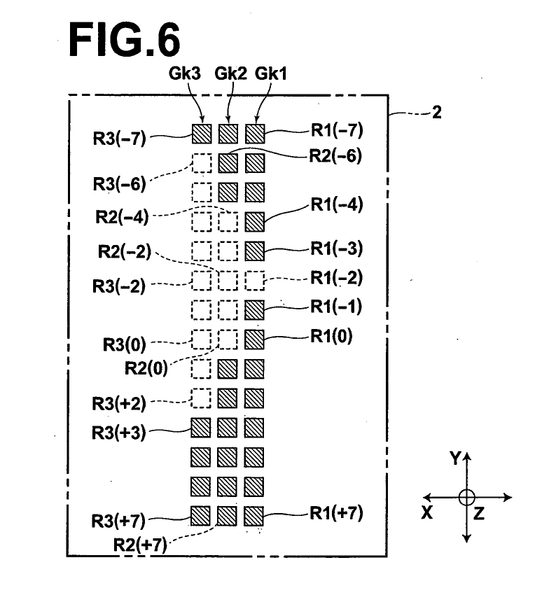

Hereinafter, embodiments of the present invention will be described with reference to the attached drawings. FIG. 1A is a conceptual diagram illustrating a projection head focus position measurement method according to an embodiment of the present invention. FIG. 1B is a conceptual diagram illustrating a projection head focus position measurement method according to an embodiment of the present invention. FIG. 2 is a diagram illustrating line portions and space portions in a test image pattern. FIGS. 3A through 3D are diagrams illustrating the process of projecting a test image pattern onto a photosensitive material while changing a projection distance. FIG. 4 is a diagram illustrating a region of a photosensitive material, onto which a test image pattern has been projected to expose the photosensitive material to light. FIG. 5 is a diagram illustrating a photosensitive material which has been exposed to light. FIG. 6 is a diagram illustrating a photosensitive material which has been developed after three kinds of test image pattern have been projected onto the photosensitive material to expose the photosensitive material to light.

The projection head focus position measurement method is a method for obtaining the focus position of an image pattern projected by a projection head 10, as illustrated in FIG. 1A.

In the projection head focus position measurement method, a photosensitive material 1 which is superposed on a substrate 2 is prepared. The photosensitive material 1 is a photosensitive material in which a region of the photosensitive material 1 which is removed from the substrate 2 when the photosensitive material 1 is developed after exposure to light and a region of the photosensitive material 1 which is not removed from the substrate 2 when the photosensitive material 1 is developed after exposure to light are determined based on the amount of exposure light and the size of an exposed area. Further, the same test image pattern Gk is projected onto each of regions R of the photosensitive material 1, which are different from each other, by a projection head 10 while a projection distance Fz, which is a distance from the projection head 10 to the photosensitive material 1, is changed. Further, the photosensitive material 1 onto which the test image pattern Gk has been projected is developed. Then, a projection distance when the test image pattern is focused on the photosensitive material 1, namely a focus position Pj1 is obtained based on a projection distance Fz which corresponds to each region in which the photosensitive material 1 has not been removed from the substrate 2 by development, and which is adjacent to a region in which the photosensitive material 1 has been removed from the substrate 2 by development, among the regions R of the photosensitive material 1, onto each of which the test image Gk has been projected. The projection distance Fz is changed by a conveyance unit 5. Further, the photosensitive material 1 is moved by the conveyance unit 5 so that the test image pattern Gk is projected onto the regions R of the photosensitive material 1, which are different from each other.

If a distance between the projection head 10 and the photosensitive material 1 is fixed with respect to the direction of the optical axis (the Z direction in FIG. 1A) and the focus position of the projection head 10 can be defocused, the focus position of the projection head 10 can be set on the photosensitive material 1, as described below. Specifically, as illustrated in FIG. 1B, the photosensitive material 1 is moved by the conveyance unit 5 in a direction (on the X-Y plane in FIG. 1B) which is orthogonal to the direction of the optical axis while the focus position Pz, at which an image pattern is accurately projected by the projection head 10, is changed (defocused). Accordingly, the test image pattern Gk is projected onto each of regions R′ of the photosensitive material 1, which are different from each other, by the projection head 10. Then, the photosensitive material 1 onto which the test image pattern Gk has been projected is developed. Then, a defocus state of the focus of the projection head 10 when the projection head 10 is focused on the photosensitive material 1, namely a focus position Pj2 can be obtained. The defocus state is obtained based on the focus position of the projection head 10 corresponding to each boundary region between a region in which the photosensitive material 1 has been removed from the substrate 2 by development and a region in which the photosensitive material 1 has not been removed from the substrate 2 by development. The focus position Pj2 when the image pattern is focused on the photosensitive material 1 can be obtained based on each of focus positions of the projection head 10, each corresponding to a boundary region. The boundary region is a region in which the photosensitive material has not been removed from the substrate 2 by development, and which is adjacent to a region in which the photosensitive material has been removed.

The photosensitive material to be prepared is a photosensitive material in which an exposed portion remains and an unexposed portion is removed when the photosensitive material is developed after exposure to light. In the exposed portion of the photosensitive material, a portion which has a size larger than an adhesion limit size, which is a predetermined exposure size, remains on the substrate. In the exposed portion of the photosensitive material, a portion which has a size smaller than the adhesion limit size is removed from the substrate.

A case in which the focus position Pj1 is obtained by projecting a test image pattern Gk onto each of the regions R while the projection distance Fz is changed will be described. The focus position Pj1 is a position on which the test image pattern is focused on the photosensitive material 1. As illustrated in FIG. 2, the test image pattern Gk includes a line portion (hereinafter, referred to as a line L) and a space portion (hereinafter, referred to as a space S). The line portion is a portion which is projected so that the photosensitive material is not removed from the substrate. The space portion is a portion which is projected so that the photosensitive is removed from the substrate. It is preferable that the width Lw of the line L, which is projected on the focus position Pj1 by the projection head 10, is less than the adhesion limit size of the photosensitive material 1. It is more preferable that the width Lw of the line L is in the range of 50% to 90% of the adhesion limit size.

Here, the adhesion limit size of the photosensitive material 1 superposed on the substrate 2 is in the range of 8 μm to 10 μm. Therefore, if a single line, of which the width is 7 μm, is accurately projected onto the photosensitive material 1 and the photosensitive material 1 is developed, a line, of which the width is 7 μm, and which has been projected onto the photosensitive material 1 to expose the photosensitive material 1 to light, does not adhere to the substrate 2. When the photosensitive material 1 is developed, the line is removed from the substrate 2.

Further, it is preferable that the width Sw of the space S, which is projected on the focus position by the projection head 10, exceeds the resolution limit size of the projection head 10. It is more preferable that the width Sw is in the range of 120% to 150% of the resolution limit size. Here, the resolution limit size of the projection head 10 is approximately 1 μm, and the width Sw of the space S is more than or equal to 12 μm.

The conditions, as described above, are considered to select a test image pattern Gk which will be projected onto the photosensitive material 1 by the projection head 10. Specifically, the following test image patterns are adopted as the test image pattern Gk:

a test image pattern Gk1 including a line portion which has a width Lw=7 μm and a space portion which has a width Sw=12 μm;

a test image pattern Gk2 including a line portion which has a width Lw=7 μm and a space portion which has a width Sw=13 μm; and

a test image pattern Gk3 including a line portion which has a width Lw=7 μm and a space portion which has a width Sw=14 μm.

The width of the line and the width of the space are those at the focus position Pj1 of the projection head 10. In other words, the width of the line and the width of the space are the width of the line and the width of the space when the test image pattern is accurately projected (formed) on the photosensitive material 1. Further, the size of a region of the photosensitive material 1, onto which any one of the test image patterns Gk1, Gk2 and Gk3 is projected, is a square, of which the side length is 2 mm. Here, the test image pattern Gk1, test image pattern Gk2 and test image pattern Gk3 are collectively referred to as test image patterns Gk.

The size of a region on the photosensitive material, onto which the test image pattern is projected, is a visible size. However, it is not necessary that the size is a visible size. The size of the region may be a size which can be observed by magnifying the region with a microscope or the like.

With reference to FIGS. 3A through 3D and FIG. 4, measurement of the focus position of the projection head 10 will be described.

First, a case in which the focus position is measured by projecting the test image pattern Gk2 onto the photosensitive material 1 will be described.

An accurate focus position of the image pattern Gk2 which is projected by the projection head 10 is unknown. Therefore, the initial position of the photosensitive material 1 is set at a projection distance Fz=Fz(0). Then, the projection distance is changed stepwise by a pitch of 50 μm.

Here, the projection distances are set as follows:

Fz(−1)={Fz(0)−50 μm};

Fz(−2)={Fz(0)−100 μm};

. . . ; and

Fz(−7)={Fz(0)−350 μm}.

Further, the projection distances are set as follows:

Fz(+1)={Fz(0)+50 μm};

Fz(+2)={Fz(0)+100 μm};

. . . ; and

Fz(+7)={Fz(0)+350 μm}.

Then, the photosensitive material 1 is positioned at a projection distance Fz=Fz(−7) from the projection head 10, and the test image pattern Gk2 is projected onto a region R2(−7).

Next, the photosensitive material 1 is moved by 50 μm in the −Z direction in FIG. 3B so that the photosensitive material 1 is positioned at a projection distance Fz=Fz(−6). Then, the test image pattern Gk2 is projected onto a region R2(−6) on the photosensitive material 1. The region R2(−6) is a region which is different from the region R2(−7).

Then, the photosensitive material 1 is moved by 50 μm in the −Z direction in FIG. 3C so that the photosensitive material 1 is positioned at a projection distance Fz=Fz(−5). Then, the test image pattern Gk2 is projected onto a region R2(−5) on the photosensitive material 1.

Further, the photosensitive material 1 is sequentially exposed to light in a similar manner. Finally, the photosensitive material 1 is positioned at a projection distance Fz=Fz(+7). Then, the test image pattern Gk2 is projected onto a region R2(+7) on the photosensitive material 1.

The projection distance may be changed not only by moving the position of the photosensitive material 1 while the position of the projection head 10 is fixed but also by moving the position of the projection head 10 while the position of the photosensitive material 1 is fixed. Alternatively, the projection distance may be changed by moving both the projection head 10 and the photosensitive material 1.

After the test image pattern Gk2 has been projected onto the photosensitive material 1, the photosensitive material 1 is developed.

As illustrated in FIG. 5, when the photosensitive material 1 is developed, the regions R2(−4) through R2(0) are removed from the substrate 2. The regions R2(−4) through R2(0) are regions which were projected when the photosensitive material 1 is positioned at a projection distance Fz=Fz(−4) through a projection distance Fz=Fz(0). Specifically, in the regions R2(−4) through R2(0), the lines L, which are exposed portions of the photosensitive material 1 in the regions R2(−4) through R2(0), are removed from the substrate 2 by development. Needless to say, the spaces S, which are unexposed portions of the photosensitive material, are removed by development at this time.

Meanwhile, the regions R2(−5) through R2(−7) and the regions R2(+1) through R2(+7) are not removed by development. The regions R2(−5) through R2(−7) are regions which were projected when the photosensitive material 1 was positioned on the front focus side of the projection distance Fz=Fz(−4). The regions R2(+1) through R2(+7) are regions which were projected when the photosensitive material 1 was positioned on the back focus side of the projection distance Fz=Fz(0). These regions adhere to the substrate 2 and remain on the substrate 2. Specifically, in the regions R2(−5) through R2(−7) and the regions R2(+1) through R2(+7), lines L, which are exposed portions of the photosensitive material, are not removed from the substrate 2. The lines L remain on the substrate 2. Here, the position of the photosensitive material 1 at which the state of the photosensitive material changes between the two states is a position between a projection distance Fz=Fz(−4) from the projection head 10 and a projection distance Fz=Fz(−5) from the projection head 10 on the front focus side. The two states are a state in which the exposed portion of the photosensitive material is removed and a state in which the exposed portion of the photosensitive material is not removed. Further, the position of the photosensitive material 1 at which the state of the photosensitive material changes between the two states is a position between a projection distance Fz=Fz(0) from the projection head 10 and a projection distance Fz=Fz(+1) from the projection head 10 on the back focus side.

Two kinds of region, in which the exposed portion of the photosensitive material has not been removed by development, and which is adjacent to one of the regions R2(−4) and R2(0), are regions R2(−5) and R2(+1). Meanwhile, the regions R2(−4) and R2(0) are regions in which the exposed portions of the photosensitive material 1 have been removed from the substrate by development. Two kinds of projection distance corresponding to the regions R2(−5) and R2(+1) are a projection distance Fz=Fz(−5) and a projection distance Fz=Fz(+1), respectively. A position corresponding to the middle projection distance between the projection distance Fz=Fz(−5) and the projection distance Fz=Fz(+1) can be determined as the focus position. Specifically, a projection distance Fp corresponding to the focus position, at which the test image pattern Gk2 is accurately formed, can be obtained by using the following equation:

Fp=(Fz(−5)+Fz(+1))/2.

Therefore, the position at which the projection distance from the projection head 10 becomes the value obtained by the above equation is the focus position Pj1.

Further, while the projection head 10 is moved in one direction, a test image pattern is sequentially projected at equal intervals onto the regions R2(−7) through R2(+7) to form regions R2. In the regions R2(−7) through R2(+7), a region R2(−2), of which the order of projection is at the middle between projection of the region R2(−5) and projection of the region R2(+1), may be selected. Then, a position at a projection distance Fz=Fz(−2), which corresponds to the region R2(−2), may be determined as the focus position at which the test image pattern Gk2 is accurately formed.

Further, as illustrated in FIG. 6, image patterns Gk1, Gk2 and Gk3 may be simultaneously projected onto the photosensitive material 1 by the projection head 10. While the image patterns Gk1, Gk2 and Gk3 are simultaneously projected, the photosensitive material 1 is moved in the Z direction. Accordingly, each region is projected onto the photosensitive material 1. Then, the photosensitive material 1 is developed. The focus position of the image pattern projected by the projection head 10 may be obtained in this manner.

For example, in the row of regions, onto each of which the image pattern Gk1 has been projected, the exposed portion (line L) and the unexposed portion (space S) in the region R1(−2) of the photosensitive material 1, which was projected at a projection distance Fz=Fz(−2), are removed by development. Therefore, the region R1(−2) of the photosensitive material 1 is removed from the substrate 2. Meanwhile, the regions R1(−3) through R1(−7), which were projected when the photosensitive material 1 was positioned on the front focus side of the position at a projection distance Fz=Fz(−2), and the regions R1(−1) through R1(+7), which were projected when the photosensitive material 1 was positioned on the back focus side of the position at a projection distance Fz=Fz(−2), are not removed by development. Therefore, the photosensitive material 1 in the regions R1(−3) through R1(−7) and the regions R1(−1) through R1(+7) remain on the substrate 2. Here, the position at which the state of the photosensitive material 1 changes between two states is a position between a projection distance Fz=Fz(−2) and a projection distance Fz=Fz(−3) on the front focus side. Further, the position at which the state of the photosensitive material 1 changes between two states is a position between a projection distance Fz=Fz(−2) and a projection distance Fz=Fz(−1) on the back focus side.

Two kinds of region, in each of which the exposed portion of the photosensitive material has not been removed from the substrate 2 by development, and which are adjacent to the region R1(−2) are the region R1(−3) and the region R1(−1). The region R1(−2) is a region in which the exposed portion has been removed from the substrate 2 by development. Two kinds of projection distance corresponding to the regions R1(−3) and R1(−1) are a projection distance Fz=Fz(−3) and a projection distance Fz=Fz(−1), respectively. Therefore, a position corresponding to the middle distance between the projection distance Fz=Fz(−3) and the projection distance Fz=Fz(−1) may be determined as the focus position. Specifically, the projection distance Fp corresponding to the focus position, at which the test image pattern Gk1 is accurately formed, can be obtained by using the following equation:

Fp=(Fz(−3)+Fz(−1))/2.

Further, the regions R1, namely the regions R1(−7) through R1(+7) are regions formed by sequentially projecting a test image pattern while the projection head 10 is moved in one direction. In the regions R1, the projection order of the region R1(−2) is at the middle between projection of the region R1(−3) and projection of the region R1(−1). A projection distance Fz=Fz(−2) which corresponds to the region R1(−2) is obtained, and a position corresponding to the projection distance Fz=Fz(−2) may be determined as the focus position, at which the test image pattern Gk1 is accurately formed.

Further, in the row of regions, each of which has been formed by projecting the test image pattern Gk3, the regions R3(−6) through R3(+2) are removed by development. The regions R3(−6) through R3(+2) are regions which were projected when the photosensitive material 1 was positioned at a projection distance Fz=Fz(−6) through a projection distance Fz=Fz(+2). Therefore, the photosensitive material 1 in the regions R3(−6) through R3(+2) is removed from the substrate 2.

Meanwhile, the region R3(−7) and the regions R3(+3) through R3(+7) are not removed by development. The region R3(−7) is a region which was projected when the photosensitive material 1 was positioned on the front focus side of a projection distance Fz=Fz(−6). The regions R3(+3) through R3(+7) are regions which were projected when the photosensitive material 1 was positioned on the back focus side of the projection distance Fz=Fz(+2). Therefore, the photosensitive material 1 in the regions R3(−7) and the regions R3(+3) through R3(+7) adheres to the substrate 2. The photosensitive material 1 in these regions remains on the substrate 2.

Two kinds of region, in each of which the exposed portion of the photosensitive material has not been removed by development, and each of which is adjacent to one of the regions R3(−6) and R3(+2), are the region R3(−7) and the region R3(+3). The regions R3(−6) and R3(+2) are regions of which the exposed portions have been removed from the substrate 2 by development. A middle projection distance between a projection distance Fz=Fz(−7) and a projection distance Fz=Fz(+3) is obtained, and a position corresponding to the middle projection distance may be determined as the focus position. The projection distance Fz=Fz(−7) is a projection distance corresponding to the region R3(−7) and the projection distance Fz=Fz(+3) is a projection distance corresponding to the region R3(+3). Therefore, a projection distance Fp corresponding to the focus position, at which the test image pattern Gk3 is accurately formed, may be obtained by using the following equation:

Fp=(Fz(−7)+Fz(+3))/2.

Further, the regions R3, namely the regions R3(−7) through R3(+7) are regions formed by sequentially projecting a test image pattern while the projection head 10 is moved in one direction. In the regions R3, the projection order of the region R3(−2) is at the middle between projection of the region R3(−7) and projection of the region R3(+3). A projection distance Fz=Fz(−2) which corresponds to the region R3(−2) is obtained, and a position corresponding to the projection distance Fz=Fz(−2) may be determined as the focus position, at which the test image pattern Gk3 is accurately formed.

As described above, each of three kinds of test image pattern is used and the focus position of the projection head 10 is determined for each of the three kinds of image pattern. Then, the focus position of the projection head 10 may be determined, for example, by obtaining an average value of the focus positions of the three kinds of image pattern. If the three kinds of test image pattern are used, as described above, it is possible to more accurately determine the focus position of the projection head 10. If three kinds of test image patter are used, as described above, the focus position can be accurately measured even if an exposure or development condition or an adhesion or resolution condition is different among the image patterns because of the difference in the shapes of the image patterns.

The process of exposing and developing a photosensitive material will be described.

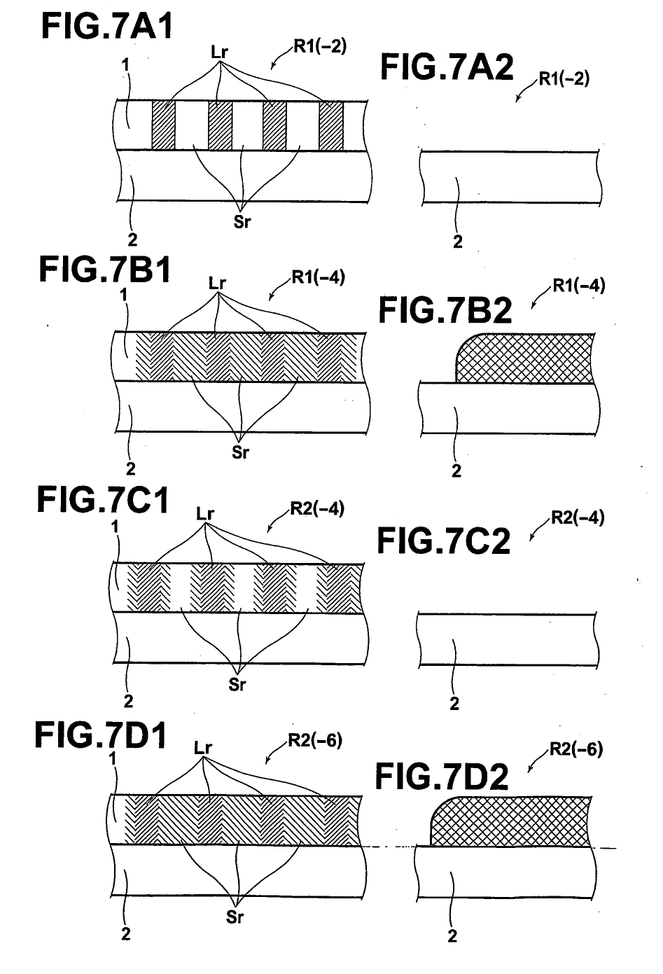

FIGS. 7A1 through 7D2 are diagrams illustrating the process of exposing and developing a photosensitive material. FIGS. 7A1 and 7A2 are diagrams illustrating a region R1(−2) of the photosensitive material. FIGS. 7B1 and 7B2 are diagrams illustrating a region R1(−4) of the photosensitive material. FIGS. 7C1 and 7C2 are diagrams illustrating a region R2(−4) of the photosensitive material. FIGS. 7D1 and 7D2 are diagrams illustrating a region R2(−6) of the photosensitive material. FIGS. 7A1, 7B1, 7C1 and 7D1 are diagrams, each illustrating the exposed state of the photosensitive material on the substrate. FIGS. 7A2, 7B2, 7C2 and 7D2, are diagrams, each illustrating the developed state of the photosensitive material on the substrate.

As illustrated in FIGS. 7A1 and 7A2, the region R1(−2), for example, is projected when the photosensitive material 1 is positioned at the focus position of the projection head 10. Therefore, the width of an exposure line Lr, which is an exposed portion formed on the photosensitive material 1, is 7 μm. The width is less than the adhesion limit size. Further, the width of an exposure space Sr, which is an unexposed portion of the photosensitive material 1, is 12 μm, which is more than or equal to the resolution limit size of the projection head 10. Therefore, the exposure line Lr is removed by development. Hence, the region R1(−2) of the photosensitive material 1 is removed by development.

Meanwhile, as illustrated in FIGS. 7B1 and 7B2, the region R1(−4), for example, is projected when the photosensitive material 1 is shifted from the focus position of the projection head 10 toward the front focus side thereof by approximately 100 μm. Therefore, the test image pattern Gk1, which is projected on the photosensitive material 1, is blurred, and the width of the exposure line Lr, which is an exposed portion formed on the photosensitive material 1, is greater than 7 μm. Further, the width of the exposure space Sr, which is an unexposed portion of the photosensitive material 1, is smaller than 12 μm. Therefore, exposure lines Lr which are adjacent to each other are connected to each other, and reinforced with each other. Accordingly, the width of an exposure line Lr which is formed by connected exposure lines Lr becomes more than or equal to the adhesion limit size. Therefore, the exposure line Lr is not removed by development, and the region R1(−4) of the photosensitive material 1 adheres to the substrate 2. Accordingly, the region R1(−4) is not removed from the substrate 2 by development.

Further, as illustrated in FIGS. 7C1 and 7C2, in the region R2(−4), which has been projected simultaneously with projection of the region R1(−4), the test image pattern Gk2 is blurred. In the region R2(−4), the width of the exposure line Lr becomes greater and the width of the space S becomes smaller in a manner similar to the region R1(−4). However, the width of the space S in the image pattern Gk2 is 13 μm, which is wider than that of the image pattern Gk1. Therefore, the width of the exposure space Sr formed in the region R2(−4) is wider than that of the exposure space Sr formed in the region R1(−4). Hence, the degree of reinforcement between the exposure lines Lr in the region R2(−4), which are formed in the photosensitive material 1, and which are adjacent to each other, is lower than that of reinforcement between the exposure lines Lr in the region R1(−4). Therefore, the size of the exposure line Lr becomes less than the adhesion limit size. Hence, the exposure line Lr is removed by development, and the region R2(−4) is removed from the substrate 2.

Further, as illustrated in FIGS. 7D1 and 7D2, the region R2(−6) is projected when the photosensitive material 1 is shifted from the focus position of the projection head 10 toward the front focus side thereof by approximately 200 μm. Therefore, the test image pattern Gk2 which is projected onto the photosensitive material 1 is further blurred, and the width of the exposure line Lr becomes even wider than that of the exposure line Lr in the region R2(−4). Further, the width of the space S is even smaller. Hence, the exposure lines Lr which are formed on the photosensitive material 1, and which are adjacent to each other, are connected to each other. Further, the degree of reinforcement between the adjacent exposure lines Lr becomes higher again, and the thickness of the exposure line Lr becomes more than or equal to the adhesion limit size. Accordingly, the exposure line Lr, which is the exposed portion in the region R2(−6) of the photosensitive material 1, is not removed by development. The region R2(−6) adheres to the substrate 2, and the region R2(−6) is not removed by development.

Here, it is preferable that the test image pattern Gk is sequentially projected onto each of regions of the photosensitive material at equal intervals by sequentially changing the projection distance by a constant distance. However, it is not necessary that the amount of change of the projection distance or the interval between the regions onto which the test image pattern Gk is projected is always constant.

Further, the two boundary regions are a boundary region which is exposed to light when the photosensitive material 1 is positioned on the front focus side of the focus position of the projection head 10 and a boundary region which is exposed to light when the photosensitive material 1 is positioned on the back focus side of the focus position of the projection head 10.

Further, it is not necessary to change the projection distance Fz stepwise. Even if the projection distance is continuously changed while the test image pattern is projected to expose the photosensitive material to light, an advantageous effect similar to the effect, as described above, can be obtained.

Further, each of regions, such as regions R1(−7), . . . R1(0), . . . and R1(+7), for example, may be projected onto photosensitive materials which are different from each other if the sensitivity of each of the photosensitive materials is the same among the photosensitive materials, and if the adhesion characteristic between the substrate and each of the photosensitive materials is the same among the photosensitive materials.

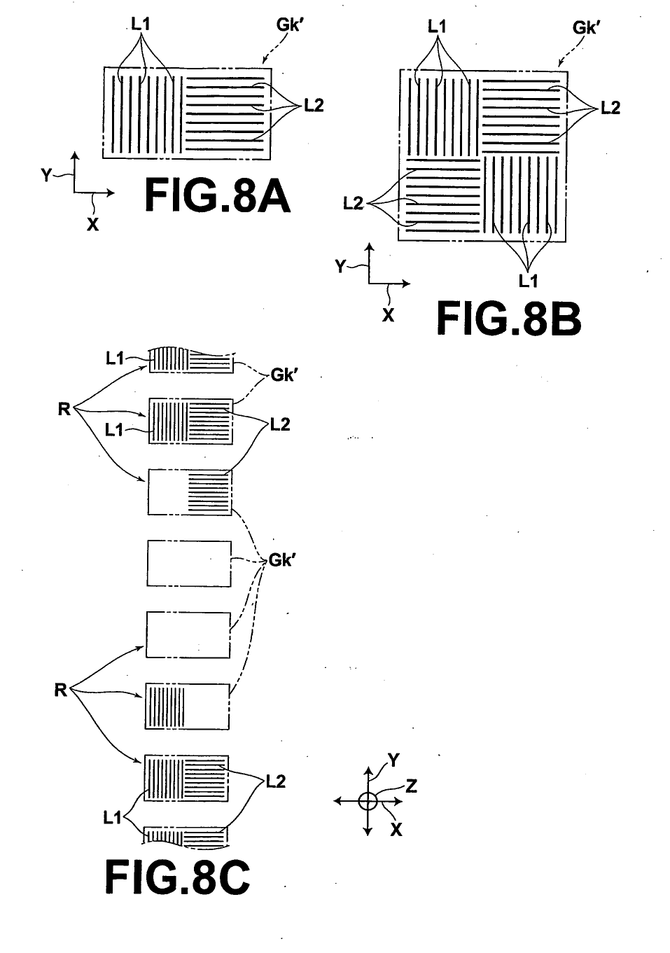

FIGS. 8A and 8B are diagrams illustrating test image patterns, each including lines orthogonal to each other. FIG. 8A is a diagram illustrating a test image pattern which includes a pair of lines orthogonal to each other. FIG. 8B is a diagram illustrating a test image pattern which includes two pairs of lines orthogonal to each other.

FIG. 8C is a diagram illustrating each of regions obtained by projecting a test image pattern illustrated in FIG. 8A onto a photosensitive material while the photosensitive material is moved stepwise and by developing the photosensitive material.

As illustrate in FIGS. 8A through 8C, if a test image pattern Gk′ including a line L1 and line L2 which are orthogonal to each other is adopted as the test image pattern, the directionality of the focus position can be taken into consideration to determine the focus position. Therefore, it is possible to obtain a more accurate focus position of the projection head.

Specifically, as illustrated in FIG. 8C, the test image pattern Gk′ is sequentially (in the Y direction in FIG. 8C) projected onto regions R of the photosensitive material 1, which are different from each other, while the photosensitive material 1 is moved stepwise, from the front focus side toward the back focus side, in the Z direction in FIG. 8C. Then, the photosensitive material 1 is developed. Accordingly, it is possible to separately determine a focus position with respect to the line L1 which extends in the Y direction in FIG. 8C and a focus position with respect to the line L2 which extends in the X direction in FIG. 8C.

Here, it is not necessary that the test image pattern includes only a line and a space.

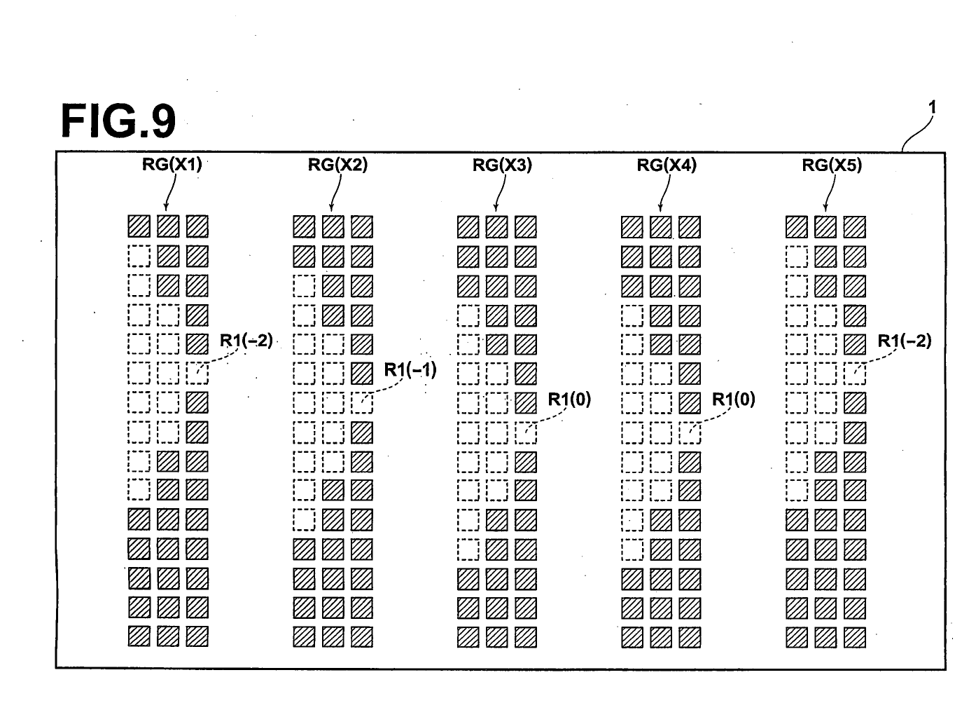

FIG. 9 is a diagram illustrating each of regions of the photosensitive material, which have been exposed to light and developed so as to check a fluctuation in the focus positions. As illustrated in FIG. 9, while the projection distance is changed, test image patterns Gk1, Gk2 and Gk3 are projected onto regions (hereinafter, referred to as a projection region group) of the photosensitive material 1. The test image patterns Gk1, Gk2 and Gk3 are projected so that the projection region groups are arranged in the X direction of the photosensitive material 1, and the photosensitive material 1 is developed. Then, the focus position of an image pattern projected by the projection head 10 is obtained for each of the projection region groups RG(X1), RG(X2), . . . RG(X5).

Here, for example, when the projection region group RG(X1) is developed, the region R1(−2) remains on the photosensitive material. The position at a projection distance Fz=Fz(−2) when the region R1(−2) was exposed to light is determined as the focus position. When the projection region group RG (X2) is developed, the region R1(−1) remains on the photosensitive material. The position at a projection distance Fz=Fz(−1) when the region R1(−1) was exposed to light is determined as the focus position.

Further, for example, when the projection region group RG (X3) is developed, the region R1(0) remains on the photosensitive material. The position at a projection distance Fz=Fz(0) when the region R1(0) was exposed to light is determined as the focus position. When the projection region group RG(X4) is developed, the region R1(0) remains on the photosensitive material. The position at a projection distance Fz=Fz(0) when the region R1(0) was exposed to light is determined as the focus position.

Further, for example, when the projection region group RG(X5) is developed, the region R1(−2) remains on the photosensitive material. The position at a projection distance Fz=Fz(−2) when the region R1(−2) was exposed to light is determined as the focus position.

Accordingly, a fluctuation in the focus position of the image pattern projected by the projection head 10 with respect to the X direction can be detected by using the method, as described above.

When a plurality of projection heads 10 is provided, the focus position of each of the projection heads 10 may be determined by forming a projection region group RG for each of the projection heads 10.

As illustrated in FIG. 1B, the distance from the projection head 10 to the photosensitive material 1 may be fixed instead of being changed. A test image pattern may be projected onto each of regions R′ of the photosensitive material 1 while the focus position of the projection head 10 is changed with respect to the direction of the optical axis (X direction in FIG. 1B). Accordingly, the focus position Pj2, which is a position when the test image pattern is focused on the photosensitive material 1, may be obtained. The technique, as described above, may also be applied to a case in which the focus position Pj2 is obtained by fixing the distance from the projection head 10 to the photosensitive material 1. Specifically, while the focus position of the projection head 10 is changed from an under-focus state to an over-focus state, a test image pattern Gk including a line and space is projected onto the photosensitive material 1 to expose the photosensitive material 1 to light. Then, the photosensitive material 1 is developed. The focus position Pj2, which is a position when the projection head 10 is focused on the photosensitive material 1, can be obtained based on the development result of the photosensitive material 1 which has been exposed to light by projection of the test image pattern Gk.

As described above, the focus position of the projection head can be more accurately determined by using the method according to the present invention. The projection head is used to expose a photosensitive material to light by projecting an image pattern onto the photosensitive material. Alternatively, the projection head is used to project an image onto a screen.

The photosensitive material to be prepared may be a photosensitive material in which an unexposed portion remains after development and an exposed portion is removed by development. Further, the photosensitive material may be a photosensitive material in which an unexposed portion of the photosensitive material, which is larger than a predetermined size, remains on the substrate and an unexposed portion of the photosensitive material, which is smaller than the predetermined size, is removed from the substrate. In such a case, the focus position of the projection head can be determined based on a projection distance corresponding to each of regions, in each of which an unexposed portion of the photosensitive material 1 has not been removed from the substrate 2 by development, and each of which is adjacent to a region in which the unexposed region of the photosensitive material 1 has been removed from the substrate 2 by development. The method for determining the focus position may be explained by replacing the exposed portion and the unexposed portion in the description of the aforementioned embodiment with each other.

In the above embodiment, a region of the photosensitive material 1 which has been removed from the substrate 2 by development and a region of the photosensitive material 1 which has not been removed from the substrate 2 are determined. In addition to removing the photosensitive material 1 from the substrate 2, etching processing may be performed on the substrate 2. Accordingly, a region of the substrate 2, in which the photosensitive material 1 has been removed, is removed. A region representing the test image pattern, which is obtained in this manner, may be used and the focus position of the projection head 10 may be determined in a manner similar to the method as described above.

Next, an exposure apparatus which is an example of a projection apparatus will be described. The exposure apparatus includes a projection head for carrying out an exposure method by adopting the projection head focus position measurement method.

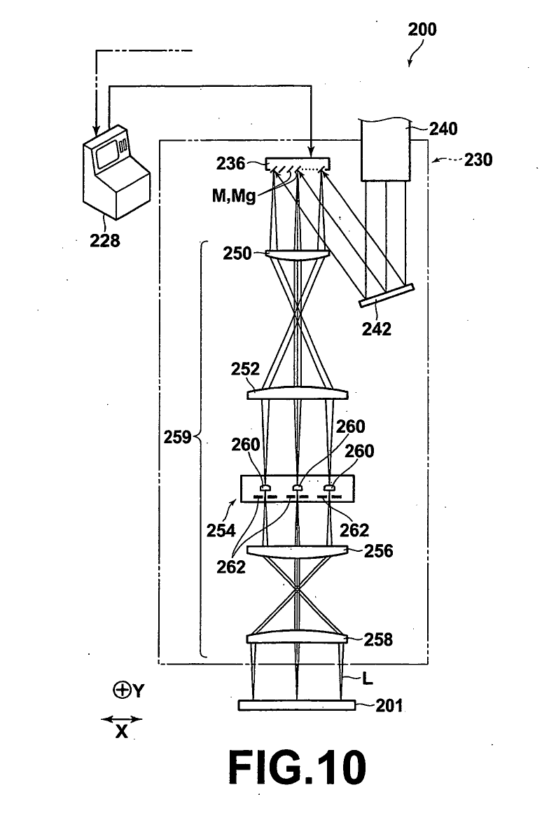

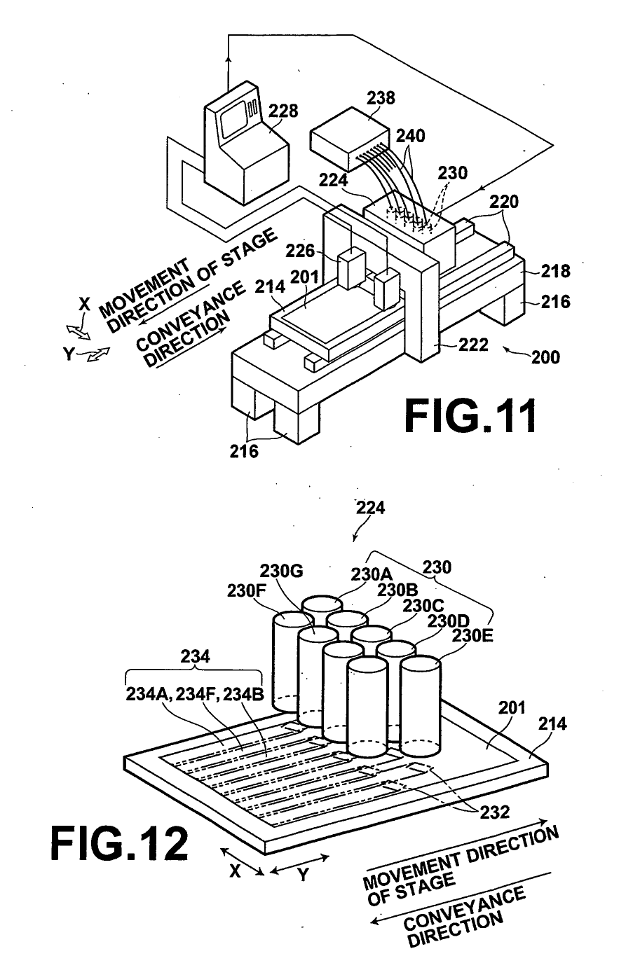

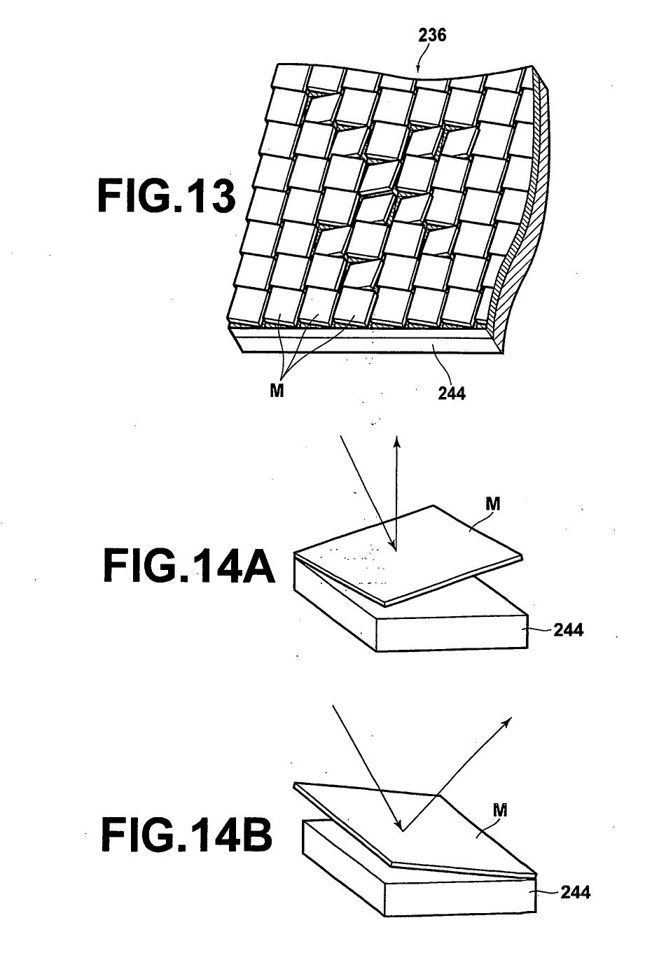

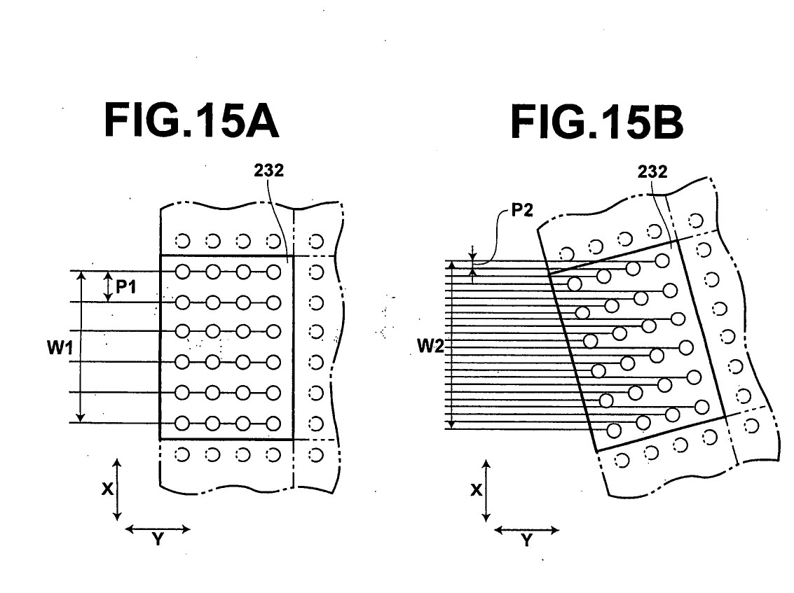

FIG. 10 is a schematic diagram illustrating the structure of an optical system of an exposure apparatus. FIG. 11 is a schematic perspective view of the whole exposure apparatus. FIG. 12 is a perspective view illustrating a process of exposing a photosensitive material to light by a projection head which is housed in an exposure unit. FIG. 13 is an enlarged perspective view illustrating the structure of a DMD, which will be described later. FIG. 14A is a perspective view illustrating the path of a pixel light beam when the DMD is off. FIG. 14B is a perspective view illustrating the path of the pixel light beam when the DMD is on. FIG. 15A is a diagram illustrating the path of a pixel light beam on the photosensitive material when the DMD is not inclined. The pixel light beam is a pixel light beam generated by being reflected by each of micromirrors. FIG. 15B is a diagram illustrating the path of a pixel light beam on the photosensitive material when the DMD is inclined.

The exposure apparatus illustrated in FIG. 10 is an exposure apparatus which performs exposure by applying the projection head position measurement method, as described above. The exposure apparatus includes a plurality of exposure heads, and each of the exposure heads includes a DMD (digital micromirror device), which is a spatial light modulator. In the spatial light modulation, a multiplicity of modulation elements is two-dimensionally arranged, and each of the modulation elements modulates incident light. In each of the exposure heads, spatial light modulation is performed on light emitted from a light source. Then, an image pattern obtained by performing spatial light modulation is formed on a photosensitive material, and the photosensitive material is developed. In the exposure apparatus, the projection head focus position measurement method is applied to measurement of the focus position of each of the exposure heads when the photosensitive material is exposed to light with the plurality of exposure heads. Then, the focus position of each of the image patterns which are formed by the exposure heads is measured. Further, a shift in the focus position of each of the image patterns formed on the photosensitive material by the exposure heads is corrected based on the measured focus position. Accordingly, the photosensitive material is exposed to light with the exposure head after the shift in the focus position is corrected.

As illustrated in FIG. 10, the exposure apparatus 200 includes a DMD (digital micromirror device) 236, which is a spatial light modulator. In the DMD, a multiplicity of micromirrors M is two-dimensionally arranged. The micromirrors M are micro light modulation elements. The DMD performs spatial light modulation on light which has been emitted from a light source 238 to the DMD through an optical fiber 240. A pixel light beam L corresponding to each of the micromirrors M is generated based on the light modulation state of each of the micromirrors M. Then, the pixel light beam L illuminates a photosensitive member 201 to form an image on the photosensitive member 201. Accordingly, an image, such as a wiring pattern, for example, is projected onto the photosensitive member 201 to expose the photosensitive member 201 to light.

The exposure apparatus 200 is a so-called flat-bed exposure apparatus. The exposure apparatus 200 includes a flat stage 214. The flat stage 214 holds the photosensitive member 201, which is a member to be exposed to light, by sucking the photosensitive member 201 onto the surface of stage 214. Further, two guides 220 extending along the movement direction of the stage is set on the surface of a setting base 218. The setting base 218 is supported by four legs 216, and the shape of the setting base 218 is a thick plate. The stage 214 is arranged so that the longitudinal direction of the stage is directed to the movement direction of the stage. The guides 220 support the stage 214 so as to allow the forward and backward movement of the stage 214. Further, a drive apparatus (not illustrated) for driving the stage 214 along the guides 220 is further provided in the exposure apparatus 200.

At the center of the setting base 218, a C-shaped gate 222 which straddles the movement path of the stage 214 is provided. Each end of the gate 222 is fixed onto either side of the setting base 218. Further, an exposure unit 224 is provided on one side of the gate 222, and a plurality (two, for example) of detection sensors 226 is provided on the other side of the gate 222. The plurality of detection sensors 226 detects the leading edge and rear edge of the photosensitive member 201. Each of the exposure unit 224 and the detection sensor 226 is attached to the gate 222. Further, each of the exposure unit 224 and the detection sensor 226 are arranged at a fixed position above the movement path of the stage 214. Here, the exposure unit 224 and the detection sensor 226 are connected to an exposure apparatus controller 228 which controls synchronization and timing of each of units in the exposure apparatus 200.

As illustrated in FIG. 12, a plurality (eight, for example) of exposure heads 230A, 230B . . . (hereinafter, collectively referred to as an exposure head 230) is provided in the exposure unit 224. The plurality of exposure heads 230 is arranged so as to substantially form a matrix with i columns and j rows (for example, 2 columns and 4 rows), as illustrated in FIG. 12.

Each of exposed areas 232 which are formed by the exposure heads 230A, 230B, . . . has, for example, a rectangular shape, of which the longitudinal side is directed to the conveyance direction (Y direction in FIG. 12). In this case, when exposure is performed, band-shaped exposed regions 234A, 234B, . . . (hereinafter, collectively referred to as exposed regions 234) are formed by the exposure heads 230 on the photosensitive member 201. The exposure heads 230 form the band-shaped exposed regions 234A, 234B, . . . , respectively.

Further, the exposure heads 230 arranged in each column are shifted from those arranged in other columns by a predetermined distance (a value obtained by multiplying the longitudinal side of an exposed area by a natural number) in the column direction. The exposure heads 230 are shifted so that the band-shaped exposed regions 234 are formed without space therebetween with respect to a direction (X direction in FIG. 12) which is orthogonal to the conveyance direction. Specifically, for example, an exposed area 232F can be formed by the exposure head 230F in a region between the exposed area 232A and the exposed area 232 B. The exposed area 232A is an area formed by the exposure head 230A, and the exposed area 232B is an area formed by the exposure head 230B.

As illustrated in FIG. 10, each of the exposure heads 230 includes a digital micromirror device (DMD) 236. The DMD 236 is a spatial light modulator for performing spatial light modulation on a light beam. The light beam is a light beam emitted from the light source 238 and transmitted through the optical fiber 240. The DMD 236 is connected to the exposure apparatus controller 228 which includes an image data processing unit, a mirror drive control unit, or the like.

In the image data processing unit of the exposure apparatus controller 228, a control signal for controlling drive of the micromirrors in the DMD 236 is generated for each of the exposure heads 230. Further, the mirror drive control unit, which is a DMD controller, controls the angle of the reflection plane of each of the micromirrors of the DMD 236 for each of the exposure heads 230. The angle is controlled based on the control signal generated by the image data processing unit.

As illustrated in FIG. 11, bundle-type optical fibers 240 are arranged on a light receiving side of the DMD 236 which is provided in each of the exposure heads 230. Each of the optical fibers 240 is extended from the light source 238. The light source 238 may be an ultraviolet lamp (UV lamp), a xenon lamp, or the like, which can be used as a general light source.

The light source 238 includes a plurality of light combination modules (not illustrated). Each of the plurality of light combination modules combines laser beams emitted from a plurality of semiconductor laser chips and causes the laser beams to enter the optical fiber. An optical fiber which extends from each of the light combination modules is an optical fiber for transmitting combined laser beams. A plurality of optical fibers is bundled to form the bundle-type optical fibers 240.

Further, as illustrated in FIG. 10, a mirror 242 is arranged on the light receiving side of the DMD 236 in each of the exposure heads 230. The mirror 242 reflects light emitted from the bundle-type optical fibers 240 to the DMD 236.

As illustrated in FIG. 13, in the DMD 236, a multiplicity of micromirrors M is two-dimensionally arranged. Each of the micromirrors M is supported by a support post (not illustrated) and arranged on a SRAM (static random access memory) cell (memory cell) 244. The DMD 236 has a rectangular shape, and the DMD 236 is a mirror device in which a multiplicity (for example, 600×800) of micromirrors M, each forming a pixel, is arranged in a grid form. Further, on the top of each pixel, a micromirror M supported by a support post is provided. Further, a material, such as aluminum, which has a high reflectance is deposited on the surface of each of the micromirrors M by vapor deposition.

Further, the SRAM cell 244 is arranged right below the micromirror M through the support post, which has a hinge and a yoke (not illustrated). The SRAM cell 244 is a silicon-gate CMOS (complimentary metal oxide semiconductor), and the CMOS is manufactured in a general production line for producing semiconductor memories. Further, the DMD, as a whole, has a monolithic (single-piece) structure.

When a digital signal is stored in the SRAM cell 244 of the DMD 236, a micromirror M supported by a support post is inclined with respect to a diagonal line of the micromirror M. The micromirror M is inclined within the range of a degrees (for example, ±10 degrees) with respect to a substrate on which the DMD is arranged. In FIG. 14A, the micromirror M is on, and the micromirror M is inclined by +α degree. In FIG. 14B, the micromirror M is off, and the micromirror M is inclined by −α degree. In the DMD, the angle of inclination of a micromirror M for each pixel of the DMD 236 is controlled based on an image signal, as described above. Accordingly, light which has entered the DMD 236 is reflected to a direction corresponding to the inclination of each of the micromirrors M.

FIG. 13 is a diagram illustrating a partial enlarged view of the DMD 236. In the example illustrated in FIG. 13, each of the micromirrors M is inclined at +α degree or −α degree. The ON/OFF of each of the micromirrors M is controlled by the exposure apparatus controller 228 which is connected to the DMD 236. For example, light reflected by the micromirror M which is on is transmitted through an imaging optical system 259 (please refer to FIG. 10), which will be described later. The imaging optical system 259 is provided on the light emitting side of the DMD 236. Then, an image is formed on the photosensitive member 201 with the light transmitted through the imaging optical system 259 and the photosensitive member 201 is exposed to light. Meanwhile, the light reflected by a micromirror M which is off enters a light absorption material (not illustrated) and the photosensitive member 201 is not exposed to light.

Further, it is preferable that the DMD 236 is slightly inclined so that the longitudinal direction of the rectangular shape of the DMD 26 forms a predetermined angle θ (for example, 0.1 degree through 0.5 degree) with respect to the conveyance direction (Y direction in FIG. 15B). FIG. 15A is a diagram illustrating the path (hereinafter, referred to as conveyance path) of a pixel light beam L on the photosensitive member 201 when the DMD 236 is not inclined. The pixel light beam L is a beam reflected by each of the micromirrors, and the conveyance path is a path of the pixel light beam, formed by the conveyance. FIG. 15B is a diagram illustrating the conveyance path of a pixel light beam L when the DMD 236 is inclined.

As described above, if the DMD 236 is inclined, it is possible to narrow a pitch P2 between conveyance lines (please refer to FIG. 15B) than a pitch P1 between conveyance lines (please refer to FIG. 15A). The pitch P1 is a pitch of conveyance lines when the DMD 236 is not inclined. Further, the conveyance lines are lines showing the conveyance path of the pixel light beam L reflected by each of the micromirrors M. Therefore, if the DMD 236 is inclined, it is possible to greatly improve the resolution of an image formed on the photosensitive member 201 when the image is formed by exposure. Meanwhile, since the angle of inclination of the DMD 236 is very small, the width W2 of conveyance when the DMD 236 is inclined and the width W1 of conveyance when the DMD 236 is not inclined are approximately the same.

Further, it is possible to arrange the DM so that substantially the same position (dot) on the same conveyance line is exposed to light a plurality of times (multiple exposure) by the rows of micromirrors, which are different from each other. In that case, the same region of the photosensitive member is exposed to light a plurality of times. Therefore, it is possible to control exposure at higher resolution, and highly accurate exposure becomes possible. Further, since exposure is performed at high resolution, it is possible to expose the photosensitive member to light so that a connection region between the exposure heads becomes unnoticeable.

Next, the imaging optical system 259 will be described. The imaging optical system 259 is provided on the light emitting side of the DMD 236 of the exposure head 230. As illustrated in FIG. 10, in the imaging optical system 259, optical elements, namely lens systems 250 and 252, a microlens array 254 and objective lens systems 256 and 258, are arranged in this order. The optical elements are arranged along the optical path from the side of the DMD 236 to the side of the photosensitive member 201.

Here, the lens systems 250 and 252 are magnification optical systems. The area of the exposed area 232 of the photosensitive member 201 is enlarged to a predetermined size by the lens systems 250 and 252. The exposed area 232 is formed by projecting a pixel light beam reflected at the DMD 236 onto the photosensitive member 201 to expose the photosensitive member 201 to light.

As illustrated in FIG. 10, the microlens array 254 includes a plurality of microlenses 260 corresponding to the micromirrors M of the DMD 236. The microlenses 260 and the micromirrors M are in one-to-one correspondence. Further, the plurality of microlenses is monolithically formed. Each of the microlenses 260 is arranged so as to transmit each of pixel light beams which have been transmitted through the lens systems 250 and 252.

The shape of the microlens array 254, as a whole, is a rectangular flat plate. At the portion of the microlens array 254 in which each of the microlenses 260 is formed, an aperture 262 (illustrated in FIG. 10) is arranged for each of the microlenses 260 in an integrated manner. The aperture 262 is formed for each of the microlenses 260 in one-to-one correspondence. According, an aperture stop is formed.

The objective lens systems 256 and 258 are, for example, 1:1 magnification optical systems which magnifies an image at 1:1. Further, the photosensitive member 201 is arranged at a position at which an image is formed with the pixel light beam L through the objective lens systems 256 and 258. In the imaging optical system 259, each of the lens systems 250 and 252 and the objective lens systems 256 and 258 is a single lens in FIG. 10. However, each of the lens systems may be formed by combining a plurality of lenses (for example, a convex lens and a concave lens).

An image can be formed on the surface of the photosensitive member 201 with the light emitted from the light source 238 by using the exposure head 230, as described above.

Next, a process of projecting an image onto the photosensitive member 201 by the exposure apparatus 200 so as to expose the photosensitive member 201 to light will be described.

First, the projection head focus position measurement method, as described above, is applied to each of the exposure heads 230A, 230B . . . , and the focus position of each of the images is measured. The focus position is a focus position when each of the images is formed on the photosensitive member 201 by each of the exposure heads 230A, 230B . . . . Then, a shift in the focus position of each of the images formed on the photosensitive member by each of the exposure heads 230A, 230B, . . . is corrected based on the measured focus position.

A laser beam, such as an ultraviolet beam, in a dispersion state is emitted from each of laser light-emitting elements in the light source 238. Then, the laser beam is collimated by a collimator lens and condensed by a condensing lens. The condensed beam is caused to enter a light receiving end of the core of a multi-mode optical fiber and combined. Then, the laser beam is emitted to an optical fiber 240 which is connected to the light emitting end of the multi-mode optical fiber (details are not illustrated).

Image data corresponding to an image which is projected to expose the photosensitive member to light is input to the exposure apparatus controller 228 which is connected to the DMD 236. The image data is temporarily stored in a memory of the exposure apparatus controller 228. The image data is data which represents the density of each pixel forming the image using two values (whether a dot is recorded or not).

The photosensitive member 201 is sucked onto the surface of the stage 214. The stage 214 is moved at a constant speed along the guides 220 by a drive apparatus, which is not illustrated. The stage 214 is moved from the upstream side toward the downstream side of the conveyance direction. When the stage 214 passes below the gate 222, the detection sensor 226, which is attached to the gate 222, detects a leading edge of the photosensitive member 201. Then, the image data stored in the memory is sequentially read out for a plurality lines. Then, the image data processing unit generates a control signal for controlling the micromirrors M for each of the exposure heads based on the image data read out from the memory.

Then, ON/OFF of each of the micromirrors of the DMD 236 is controlled for each of the exposure heads 230 by a mirror drive control unit of the exposure apparatus controller 228. The ON/OFF is controlled based on a control signal on which shading adjustment and exposure amount adjustment have been performed. The shading adjustment and the exposure amount adjustment are performed so that light amounts become evenly distributed.

The light beam is emitted from the optical fiber 240 and reflected by the mirror 242. Then, the light beam illuminates the DMD 236. The laser light which is reflected by the DMD 236 when the micromirror of the DMD 236 is on is transmitted through a lens system including a microlens 260 in the microlens array 254, which corresponds to the micromirror. Then, an image is formed on the exposure surface of the photosensitive member 201. As described above, ON/OFF of the pixel light beam L emitted from the DMD 236 is controlled for each of the micromirrors. Accordingly, the photosensitive member 201 is exposed to light so that pixel units (exposure areas), of which the number is approximately the same as the number of pixels used in the DMD 236, are projected onto the photosensitive member 201 to expose the photosensitive member 201 to light.

Further, since the photosensitive member 201 is moved together with the stage 214 at a constant speed, the photosensitive member 201 relatively moves, with respect to the exposure unit 224, in a direction opposite to the movement direction of the stage. Accordingly, a band-shaped exposed region 234 is formed by each of the exposure heads 230, and the photosensitive member is exposed to light to form an image on the photosensitive member.

Specifically, the image is formed on the photosensitive member 201 by illuminating the photosensitive member 201 with the pixel light beam L. The pixel light beam L is a beam generated by performing modulation corresponding to the image formed by exposing the photosensitive member to light. The modulation is performed by the DMD 236.

When exposure of the photosensitive member 201 by the exposure unit 224 ends and the detection sensor 226 detects the rear edge of the photosensitive member 201, the stage 214 is returned to the origin which is on the most upstream side of the conveyance direction. The stage 214 is returned along the guides 220 by a drive apparatus, which is not illustrated. Then, the stage 214 is moved again along the guides 220 at a constant speed from the upstream side toward the downstream side of the conveyance direction.

In the exposure apparatus 200 according to the present embodiment, the DMD is used as the spatial light modulator which is used in the exposure head 230. However, other kinds of device may be used instead of the DMD. For example, a spatial light modulator (SLM: spatial light modulator) of an MEMS (Micro Electro Mechanical Systems) type may be used as the spatial light modulator. A grating light valve element (GLV element produced by Silicon Light Machines) of a reflection diffraction grating type may also be used as the spatial light modulator. The GLV element is formed by arranging a plurality of gratings in one direction. (The GLV element is described in detail in U.S. Pat. No. 5,311,360. Therefore, the description of the GLV element is omitted.) Further, an optical element (PLZT element: piezo-electric lanthanum-modified lead zirconate titanate) for modulating transparent light by an electro-optical effect may also be used as the spatial light modulator. Further, a spatial light modulator of a transparent type, such as a liquid crystal light shutter (FLC: ferroelectric liquid crystal), or a spatial light modulator other than the MEMS type may also be used as the spatial light modulator.

Here, the term “MEMS” is used as a generic term representing a micro system, in which a micro-size sensor, actuator and control circuit using a micro-machining technique based on an IC production process are integrated. The spatial light modulator of the MEMS type refers to a spatial light modulator which is driven by an electro mechanical operation using electrostatic power.

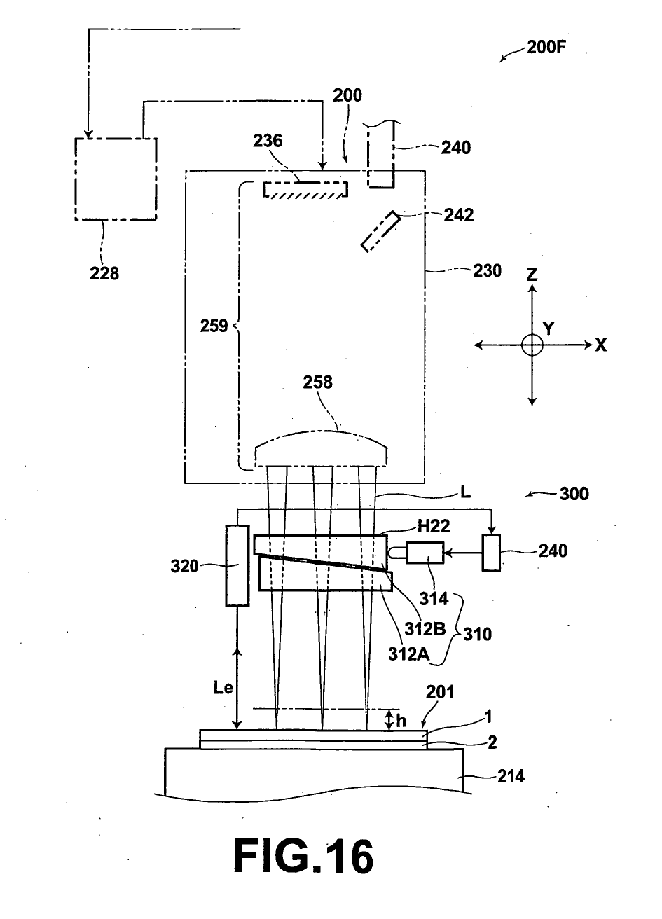

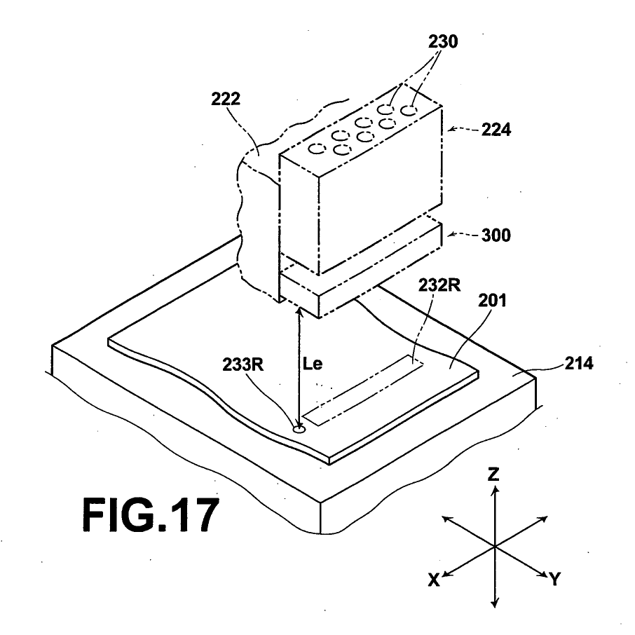

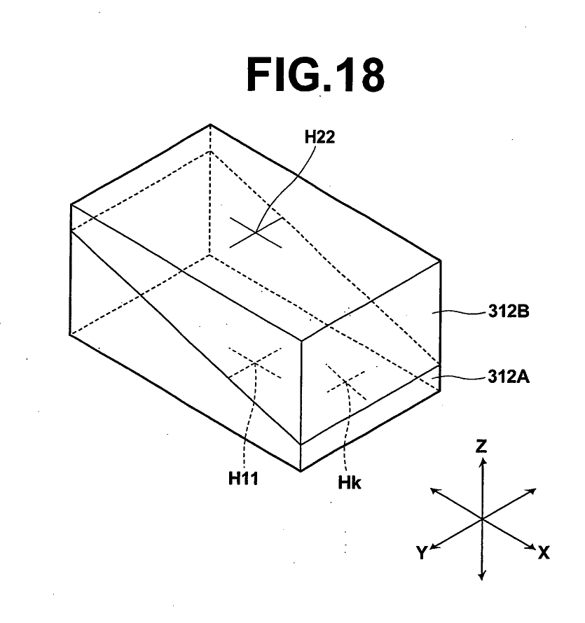

A case in which the projection head focus position measurement method according to the present invention is applied to an exposure apparatus 200F will be described. The exposure apparatus 200F is an apparatus in which a focus position automatic adjustment unit is added to the exposure apparatus 200. FIG. 16 is a schematic diagram illustrating the structure of a focus position automatic adjustment unit. FIG. 17 is a perspective view illustrating a position in an exposure apparatus, to which the focus position automatic adjustment unit is attached. FIG. 18 is an enlarged perspective view illustrating a pair of wedge prisms, which forms a part of the focus position automatic adjustment unit.

In the exposure apparatus 200F, a focus position automatic adjustment unit 300 is added to the exposure apparatus 200. Therefore, even if the photosensitive member 201, which is placed on the stage 214 and conveyed, is distorted, it is possible to compensate and correct the distortion when a test image pattern Gk is projected onto the photosensitive member 201. Accordingly, the test image pattern Gk can be projected onto the photosensitive member 201 in a condition similar to that of a test image pattern Gk projected when the photosensitive member 201 is not distorted.

Specifically, the focus position of the exposure head 230 can be automatically positioned on the distorted photosensitive member 201 which is conveyed. The focus position is automatically positioned, for example, by keeping a constant distance between the exposure head 230 and the exposure region on the photosensitive member 201, which is exposed to light by the exposure head 230. Further, the focus position of the exposure head 230 may be automatically positioned at a predetermined distance h from the distorted photosensitive member 201 with respect to the Z direction in FIG. 16.

If the focus position automatic adjustment unit is added to the exposure apparatus, as described above, even if the photosensitive member 201 is distorted, it is possible to treat the photosensitive member 201 in a manner similar to the case in which the photosensitive member 201 is not distorted. Therefore, in the exposure apparatus to which the focus position automatic adjustment unit is added, the projection head focus position measurement method can be applied without considering the distortion of the photosensitive member 201. In other words, even if the photosensitive member 201 is actually distorted, the projection head focus position measurement method may be applied as if the photosensitive member 201 is not distorted.

The focus position automatic adjustment unit 300 includes an air gap adjustment unit 310, a length measurement unit 320 and a control unit 240.

The air gap adjustment unit 310 is inserted between the photosensitive member 201 and the imaging optical system 259. The photosensitive member 201 is formed by superposing a photosensitive material 1 on a substrate 2 and placed on the stage 214. The air gap adjustment unit 310 changes the air gap between the photosensitive member 201 and the imaging optical system 259.

The length measurement unit 320 is arranged at the gate 222, and a positional relationship between the length measurement unit 320 and the exposure head 230 is fixed. The length measurement unit 320 measures a distance to a region 232R on the photosensitive member 201, onto which an image pattern is projected by the exposure head 230, or a distance to a region on the photosensitive member 201, which is in the vicinity of the region 232R, by use of laser light Le.

The control unit 240 changes the air gap based on the value of the distance measured by the length measurement unit 320. Further, the control unit 240 controls the focus position of the exposure head 230 so that the focus position is positioned on the photosensitive member 201 or at a predetermined distance h from the photosensitive member 201 with respect to the Z direction in FIG. 16.

The air gap adjustment unit 310 includes a wedge prism 312A and a wedge prism 312B, which together form a pair of wedge prisms, as illustrated in FIGS. 16 and 18. The air gap adjustment unit 310 also includes a drive unit 314 for moving the wedge prism 312B with respect to the wedge prism 312A.

The pair of wedge prisms may be formed, for example, by cutting a parallel flat plate made of a transparent material, such as glass or acrylic, with a flat plane Hk. The flat plane Hk is a plane which inclines diagonally with respect to the parallel flat surfaces H11 and H22 of the parallel flat plate.

The wedge prism 312B is moved with respect to the wedge prism 312A by the drive unit 314. Accordingly, the substantial thickness of the parallel flat plate formed by the pair of wedge prisms 312A and 312B is changed, and the air gap between the photosensitive member 201 and the imaging optical system 259 is adjusted. Here, a value obtained by multiplying the substantial thickness of the parallel flat plate by the refractive index of the parallel flat plate is a value obtained by converting the thickness of an air gap formed by the parallel flat plate into the thickness of air. The thickness of the air gap is the thickness of the parallel flat plate.

The air gap adjustment unit 310 is arranged so that the flat surfaces H22 and H11 are substantially orthogonal to the direction of the optical axis (Z direction in FIG. 16) of light flux emitted from the imaging optical system 259. The flat surfaces H22 and H11 are parallel flat surfaces of the parallel flat plate, formed by the pair of wedge prisms 312A and 312B.

An operation of the focus position automatic adjustment unit 300 will be described.

The photosensitive member 201 is moved together with the stage 214 in a sub-scan direction (Y direction in FIG. 16). Each of the exposure heads 230A, 230B . . . projects an image pattern onto a band-shaped region 232R which extends in the main scan direction (X direction in FIG. 16), which is orthogonal to the sub-scan direction.

Here, a warp or wave is present on the photosensitive member 201 with respect to the Y direction (for example, a warp or wave of approximately 100 μm is present). Since no warp or wave is present with respect to the X direction, the warp or wave is measured by the length measurement unit 320. Specifically, the position of the exposure head 230 is used as a standard position, and a distance to the region 232R on the photosensitive member 201, onto which an image pattern is projected by the exposure head 230, or a distance to a region 233R on the photosensitive member 201, which is in the vicinity of the region 232R, is measured by use of the laser light Le.

For example, when the upper surface of the stage 214 is used as a standard surface, if the distance from the exposure head 230 to the standard surface, which is measured by the length measurement unit 320, is 30 mm, and if the thickness of the photosensitive member 201 is 1 mm and if the photosensitive member is not distorted, the distance to the region 232R on the photosensitive member 201, onto which the image pattern is projected by the exposure head 230, should be measured as 29 mm by the length measurement unit 320.

Meanwhile, when the value of the distance from the exposure head 230 to the region 232R on the photosensitive member 201, which has been measured by the length measurement unit 320, is input to the control unit 240, the control unit 240 obtains a difference between the value of an ideal distance (29 mm, as described above) and the value of the measured distance. The ideal distance is a distance from the exposure head 230 to the photosensitive member 201 when the photosensitive member 201 is not distorted, and which has been input and stored in advance. Further, the measured distance is a distance from the exposure head 230 to the regions 232R, which has been measured by the length measurement unit 320 with respect to the distorted photosensitive member 201.

Next, the control unit 240 outputs a difference signal representing the difference between the value of the ideal distance and the value of the measured distance to the drive unit 314. The drive unit 314 moves the wedge prisms 312B in the X direction. Accordingly, the focus position of the projection head 230 is moved in the Z direction, illustrated in FIG. 16. The focus position is moved by the difference. Consequently, the focus position of the exposure head 230 can be positioned on the distorted photosensitive member 201.

Further, when the focus position of the exposure head 230 should be positioned at 1 mm distance above the distorted photosensitive member 201, a distance to a position at 1 mm distance above the undistorted photosensitive member 201 with respect to the Z direction should be adopted as the ideal distance.

It is not necessary that the air gap adjustment unit 310 is inserted between the photosensitive member 201 and the imaging optical system 259, as described above. A similar advantageous effect can be obtained by inserting the air gap adjustment unit 310 between the objective lens system 256 and the microlens array 254.

1.-16. (canceled)

17. A projection head focus position measurement method for measuring the focus position of a projection head, comprising the steps of:
preparing a photosensitive material which is superposed on a substrate;
projecting a test image pattern onto each of regions of the photosensitive material, which are different from each other, by a projection head while changing one of a projection distance from the projection head to the photosensitive material, onto which the image pattern is projected by the projection head, and the focus position of the projection head;
developing the photosensitive material onto which the test image pattern has been projected; and
determining a focus position to be selected, wherein the photosensitive material is a photosensitive material in which a region of the photosensitive material which is removed from the substrate when the photosensitive material is developed after exposure to light and a region of the photosensitive material which is not removed from the substrate when the photosensitive material is developed after exposure to light are determined based on the amount of exposure light and the size of an exposed area, and wherein the focus position to be selected is determined based on one of a projection distance and the focus position of the projection head which correspond to a boundary region between a region in which the photosensitive material has been removed from the substrate by development and a region in which the photosensitive material has not been removed from the substrate by development.

18. A projection head focus position measurement method as defined in claim 17, wherein the test image pattern includes a line portion which is projected so that the photosensitive material is not removed from the substrate and a space portion which is projected so that the photosensitive material is removed from the substrate.

19. A projection head focus position measurement method as defined in claim 18, wherein the width of the line portion projected on the focus position by the projection head is less than the adhesion limit size of the photosensitive material with respect to the substrate.

20. A projection head focus position measurement method as defined in claim 19, wherein the width of the line portion is in the range of 50% to 90% of the adhesion limit size.

21. A projection head focus position measurement method as defined in claim 18, wherein the width of the space portion projected on the focus position by the projection head is greater than the resolution limit size of the projection head.

22. A projection head focus position measurement method as defined in claim 21, wherein the width of the space portion is in the range of 120% to 150% of the resolution limit size.

23. A projection head focus position measurement method as defined in claim 17, wherein the size of a region of the photosensitive material, onto which the test image pattern has been projected, is a visible size.

24. A projection head focus position measurement method as defined in claim 17, wherein the boundary region is a region in which the photosensitive material has not been removed from the substrate by development, and which is adjacent to a region in which the photosensitive material has been removed from the substrate by development.

25. A projection head focus position measurement method as defined in claim 17, wherein the focus position to be selected is determined by further performing etching processing on the substrate after the photosensitive material is developed.

26. A projection head focus position measurement method as defined in claim 17, wherein a plurality of projection heads is provided, and wherein a focus position to be selected is determined for each of the plurality of projection heads.

27. A projection head focus position measurement method as defined in claim 17, wherein the focus position to be selected is one of the middle position of projection distances, each corresponding to one of two boundary regions which are present among the regions of the photosensitive material, and the middle position of the focus positions of the projection head, each corresponding to one of the two boundary regions which are present among the regions of the photosensitive material.

28. A projection head focus position measurement method as defined in claim 18, wherein the focus position to be selected is one of the middle position of projection distances, each corresponding to one of two boundary regions which are present among the regions of the photosensitive material, and the middle position of the focus positions of the projection head, each corresponding to one of the two boundary regions which are present among the regions of the photosensitive material.

29. A projection head focus position measurement method as defined in claim 19, wherein the focus position to be selected is one of the middle position of projection distances, each corresponding to one of two boundary regions which are present among the regions of the photosensitive material, and the middle position of the focus positions of the projection head, each corresponding to one of the two boundary regions which are present among the regions of the photosensitive material.

30. A projection head focus position measurement method as defined in claim 21, wherein the focus position to be selected is one of the middle position of projection distances, each corresponding to one of two boundary regions which are present among the regions of the photosensitive material, and the middle position of the focus positions of the projection head, each corresponding to one of the two boundary regions which are present among the regions of the photosensitive material.

31. A projection head focus position measurement method as defined in claim 17, wherein the regions of the photosensitive material which are different from each other, and onto each of which the test image pattern is projected, are arranged in a row.

32. A projection head focus position measurement method as defined in claim 18, wherein the focus position to be selected is determined based on one of a projection distance and the focus position of the projection head, each corresponding to a boundary region obtained for each of two or more kinds of test image pattern, and wherein the two or more kinds of test image pattern are patterns, each including a line portion and a space portion, and wherein the width of the line portion and/or space portion in each of the image patterns is different from the width of the line portion and/or space portion in the other image pattern or image patterns.

33. A projection head focus position measurement method as defined in claim 18, wherein the focus position to be selected is determined based on one of a projection distance and the focus position of the projection head, each corresponding to a boundary region obtained for each of two or more kinds of test image pattern, and wherein the two or more kinds of test image pattern are image patterns, each including a line portion, and wherein the direction of the line portion in each of the image patterns is different from the direction of the line portion in the other image pattern or image patterns.

34. A projection head focus position measurement method as defined in claim 17, wherein when the photosensitive material is distorted, the test image pattern is projected by compensating the distortion so that the test image pattern is projected onto the photosensitive material in a condition similar to that of an image pattern projected when the photosensitive material is not distorted.

35. An exposure method comprising the steps of:
obtaining an image pattern by performing spatial light modulation on light emitted from a light source; and
exposing a photosensitive material to light by forming the image pattern on the same photosensitive material by each of a plurality of exposure heads, each including a spatial light modulator, wherein the spatial light modulator includes a multiplicity of two-dimensionally arranged modulation elements which modulate incident light, and wherein the focus position of each of the exposure heads is measured by applying the projection head focus position measurement method as defined in claim 17 to measurement of a focus position when the photosensitive material is exposed to light by the plurality of exposure heads, and wherein the photosensitive material is exposed to light by each of the exposure heads by correcting, based on the focus position of each of the exposure heads, a shift in the focus position of the image pattern projected onto the photosensitive material by each of the exposure heads.
